(19) United States
(12) Patent Application Publication
(10) Pub. No.: US 2014/0370476 A1
(43) Pub. Date: Dec. 18, 2014

(54) Computer-Implemented Training of a Procedure

(71) Applicant: DyAnsys, Inc., San Mateo, CA (US)

(72) Inventor: Srini Nageshwar, Los Gatos, CA (US)

(21) Appl. No.: 13/916,975

(22) Filed: Jun. 13, 2013

(51) Int. Cl. G09B 7/00; G09B 23/30; G09B 23/28

(52) U.S. Cl. CPC G09B 7/00; G09B 23/28; G09B 23/30
USPC 434/270; 434/362; 434/262; 434/267

(57) ABSTRACT

A computer-implemented method for training a user in a procedure includes registering a profile of the user, and receiving a selection of a training aid from a menu using a graphical user interface of the computer. The method further includes displaying the training aid on the graphical user interface of the computer. The training aid is responsive to an input from the user. The training aid accesses a storage space of the computer including a first database storing a graphical representation associated with the procedure, and a second database storing a multitude of questions and a multitude of associated answers. The storage space further includes a third database storing a multitude of symptoms and a multitude of associated solutions, and a fourth database storing a multitude of sequences associated with the procedure.

### CROSS-REFERENCES TO RELATED APPLICATIONS

This application is related to U.S. Pat. No. 7,092,849, titled “EXTRACTING CAUSAL INFORMATION FROM A CHAOTIC TIME SERIES,” granted Aug. 15, 2006, the content of which is incorporated herein by reference in its entirety. This application is also related to the following applications filed herewith: U.S. patent application Attorney Docket No. 89562-000300US-874038, titled “STIMULATIVE ELECTROTHERAPY USING AUTONOMIC NERVOUS SYSTEM CONTROL,” U.S. patent application Attorney Docket No. 89562-000400US-874044, titled “METHOD AND APPARATUS FOR AUTONOMIC NERVOUS SYSTEM SENSITIVITY-POINT TESTING,” and U.S. patent application Attorney Docket No. 89562-001000US-876815, titled “METHOD AND APPARATUS FOR STIMULATIVE ELECTROTHERAPY,” the contents of all of which are incorporated herein by reference in their entirety.

### BACKGROUND

The disclosure relates generally to a computer-implemented method for training a user in a procedure.

Various application software tools are ubiquitous on desktop, laptop, and portable computing devices such as smart phones and tablets running on mobile operating systems such as Android® from Google Inc. or iOS® from Apple Inc., and the like.

Training instruction guides are available in printed matter as books, pamphlets, or specifications that describe procedures available with the use of various devices or techniques that are unfamiliar to the student user. Such printed matter may be unwieldy in certain situations such as a crowded repair shop or medical treatment settings. Video instructions teaching various procedures are available on sources such as YouTube™ on the World Wide Web but lack facility to test the student's knowledge.

The autonomic nervous system plays an important role in pain modulation and perception and chronic pain is likely due to a malfunction in the body's central nervous system. While there are many medications and physical therapies that are used to treat pain, they do not cure it and only mask the pain response, sometimes with undesired side effects such as with narcotic medications.

A point stimulation device is a non-narcotic combination of permanent acupuncture-like needles and electrical stimulation used to treat chronic pain over time. A point stimulation device uses auricular acupuncture as a treatment based on normalizing the body's dysfunction through stimulation of points on the ear. The resulting amelioration of pain and illness is believed to be through the reticular formation and the sympathetic and parasympathetic nervous systems. Specific points in the ear are related to major organs in the body. However, existing printed or video training aids for testing and locating sensitivity-points on the skin surface for point stimulation needle insertion have not taken advantage of computer-implemented training methods.

### SUMMARY

According to one embodiment of the present invention, a computer-implemented method for training a user in a procedure includes registering, with one or more processors associated with a computer, a profile of the user, and receiving, with the one or more processors, a selection of a training aid from a menu using a graphical user interface of the computer. The computer-implemented method for training a user in the procedure further includes displaying, with the one or more processors, the training aid on the graphical user interface of the computer. The training aid is responsive to an input from the user. The training aid accesses, with the one or more processors, a storage space of the computer including a first database storing a graphical representation associated with the procedure, and a second database storing a multitude of questions and a multitude of associated answers. The multitude of questions is associated with the procedure. The storage space of the computer further includes a third database storing a multitude of symptoms and a multitude of associated solutions. The multitude of symptoms is associated with the procedure. The storage space of the computer further includes a fourth database storing a multitude of sequences associated with the procedure.

According to one embodiment, the procedure includes a stimulative electrotherapy. According to one embodiment, displaying, with the one or more processors, the training aid includes displaying, with the one or more processors, on the graphical user interface the graphical representation, and receiving, with the one or more processors, a selection of one of a multitude of locations on the graphical representation using the graphical user interface. Displaying the training aid further includes accessing, with the one or more processors, a description associated with the selection from a fifth database, and displaying, with the one or more processors, on the graphical user interface the description on the graphical user interface. Displaying the training aid further includes repeating, with the one or more processors, displaying the graphical representation, receiving a selection, accessing a description, and displaying the description until an exit command is received.

According to one embodiment, the method includes displaying, with the one or more processors, on the graphical user interface a multitude of icons associated with a multitude of graphical views of the graphical representation, and receiving, with the one or more processors, a selection of one of the multitude of icons associated with the multitude of graphical views using the graphical user interface. The method further includes displaying, with the one or more processors, on the graphical user interface a selected one of the multitude of graphical views on the graphical user interface. According to one embodiment, displaying, with the one or more processors, the training aid further includes returning, with the one or more processors, to receiving a selection of a training aid from a menu when an exit command is received.

According to one embodiment, the graphical representation includes a portion of an anatomy of a patient. According to one embodiment, the portion of the anatomy includes a skin surface. According to one embodiment, the skin surface includes an ear. According to one embodiment, the description includes a symptom of a patient.

According to one embodiment, the description includes a symptom treated with a stimulative electrotherapy based on a western medicine protocol. According to one embodiment, the description includes a symptom treated with a stimulative electrotherapy based on an eastern medicine protocol.

According to one embodiment, displaying, with the one or more processors, the training aid includes accessing, with the one or more processors, at least one of the multitude of questions and at least one of the multitude of associated answers, and displaying, with the one or more processors, on the graphical user interface the at least one of the multitude of questions on the graphical user interface. Displaying the training aid further includes receiving, with the one or more processors, an answer input using the graphical user interface, and determining, with the one or more processors, when a last question is displayed based on a predetermined number of questions to be accessed from the second database. Displaying the training aid further includes repeating, with the one or more processors, when the last question is not displayed, displaying the at least one of the multitude of questions, receiving an answer input, and determining. According to one embodiment, displaying, with the one or more processors, the training aid further includes returning, with the one or more processors, to receiving a selection of a training aid from a menu when the last question is displayed.

According to one embodiment, displaying, with the one or more processors, the training aid further includes displaying, with the one or more processors, on the graphical user interface a multitude of icons associated with a multitude of training modes. Displaying the training aid further includes receiving, with the one or more processors, a selection of one of the multitude of icons using the graphical user interface.

According to one embodiment, displaying, with the one or more processors, the training aid further includes comparing, with the one or more processors, the answer input with the at least one of the multitude of associated answers, and determining, with the one or more processors, a comparison outcome based on comparing the answer input with the at least one of the multitude of associated answers. The comparison outcome is positive if the answer input equals the at least one of the multitude of associated answers. The comparison outcome is negative if the answer input does not equal the at least one of the multitude of associated answers. Displaying the training aid further includes determining, with the one or more processors, a number of positive or negative comparison outcomes, and displaying, with the one or more processors, on the graphical user interface the number of positive or negative comparison outcomes.

According to one embodiment, displaying, with the one or more processors, the training aid further includes displaying, with the one or more processors, on the graphical user interface the answer input and the at least one of the multitude of associated answers. According to one embodiment, accessing, with the one or more processors, the at least one of the multitude of questions and the at least one of the multitude of associated answers is done in a predetermined order, wherein repeating, with the one or more processors, includes accessing. According to one embodiment, accessing, with the one or more processors, the at least one of the multitude of questions and the at least one of the multitude of associated answers is done in a random order to select a predetermined number of questions.

According to one embodiment, the least one of the multitude of questions is associated with a treatment of a dysfunction of a patient. According to one embodiment, the treatment is associated with a stimulative electrotherapy.

According to one embodiment, displaying, with the one or more processors, the training aid includes displaying, with the one or more processors, on the graphical user interface a portion of the multitude of symptoms, and receiving, with the one or more processors, a selected one of the portion of the multitude of symptoms using the graphical user interface. Displaying the training aid further includes accessing, with the one or more processors, one of the multitude of associated solutions based on the selected one of the portion of the multitude of symptoms, and displaying, with the one or more processors, on the graphical user interface the one of the multitude of associated solutions. According to one embodiment, displaying, with the one or more processors, the training aid further includes returning, with the one or more processors, to receiving a selection of a training aid from a menu after displaying the one of the multitude of associated solutions.

According to one embodiment, displaying, with the one or more processors, the training aid further includes displaying, with the one or more processors, on the graphical user interface a multitude of icons associated with a multitude of display modes. Displaying the training aid further includes receiving, with the one or more processors, a selection of one of the multitude of icons using the graphical user interface. According to one embodiment, displaying, with the one or more processors, the multitude of symptoms includes displaying, with the one or more processors, on the graphical user interface a table of the portion of the multitude of symptoms until the selected one of the portion of the multitude of symptoms is received.

According to one embodiment, displaying, with the one or more processors, the multitude of symptoms includes displaying, with the one or more processors, on the graphical user interface a graphical view related to the multitude of symptoms and stored in a fifth database, and receiving, with the one or more processors, a selection of one of a multitude of locations on the graphical view using the graphical user interface. The selection is associated with the selected one of the portion of the multitude of symptoms.

According to one embodiment, the multitude of symptoms are associated with a dysfunction of a patient. According to one embodiment, the multitude of associated solutions are associated with a multitude of locations on a skin of the patient associated with a stimulative electrotherapy.

According to one embodiment, displaying, with the one or more processors, the training aid includes displaying, with the one or more processors, on the graphical user interface one of the multitude of sequences, and determining, with the one or more processors, when a last one of the multitude of sequences is displayed based on a predetermined number of sequences. Displaying the training aid further includes repeating, with the one or more processors, displaying one of the multitude of sequences, and determining when the last one of the multitude of sequences is not displayed. According to one embodiment, displaying, with the one or more processors, the training aid further includes returning, with the one or more processors, to receiving a selection of a training aid from a menu when the last one of the multitude of sequences is displayed.

According to one embodiment, the multitude of sequences are displayed in a predetermined order. According to one embodiment, displaying, with the one or more processors, one of the multitude of sequences includes displaying, with the one or more processors, a text of one of the multitude of sequences. According to one embodiment, displaying, with the one or more processors, one of the multitude of sequences includes displaying, with the one or more processors, a video of one of the multitude of sequences. According to one embodiment, displaying, with the one or more processors, one of the multitude of sequences includes displaying, with the one or more processors, a text of one of the multitude of sequences, and displaying, with the one or more processors, a video of one of the multitude of sequences. According to one embodiment, one of the multitude of sequences includes a portion of a solution procedure.

According to one embodiment, registering, with one or more processors associated with a computer, the profile of the user includes accessing, with the one or more processors, the profile from a fifth database storing the profile of the user, and displaying, with the one or more processors, on the graphical user interface the profile. Registering the profile of the user further includes editing, with the one or more processors, the profile using the graphical user interface, and storing, with the one or more processors, the profile in the fifth database when the editing is completed. According to one embodiment, registering, with the one or more processors, a profile of the user further includes returning, with the one or more processors, to receiving a selection of a training aid from a menu when the storing is completed.

According to one embodiment, displaying, with the one or more processors, the training aid includes accessing, with the one or more processors, an email address from the profile from a fifth database storing the profile of the user, and composing, with the one or more processors, an email to an entity associated with the procedure. Displaying the training aid further includes sending, with the one or more processors, the email to the entity. According to one embodiment, the entity is a manufacturer and the email is composed so as to request the manufacturer contact the user. According to one embodiment, registering, with the one or more processors, a profile of the user further includes returning, with the one or more processors, to receiving a selection of a training aid from a menu when the sending is completed.

According to one embodiment of the present invention, a non-transitory computer-readable medium stores computer-executable code for training a user in a procedure including code for registering a profile of the user, code for receiving a selection of a training aid from a menu using a graphical user interface of the computer, and code for displaying the training aid on the graphical user interface of the computer. The training aid is responsive to an input from the user. The training aid accesses a storage space of the computer including a first database storing a graphical representation associated with the procedure, and a second database storing a multitude of questions and a multitude of associated answers. The multitude of questions is associated with the procedure. The storage space of the computer further includes a third database storing a multitude of symptoms and a multitude of associated solutions. The multitude of symptoms is associated with the procedure. The storage space of the computer further includes a fourth database storing a multitude of sequences associated with the procedure.

According to one embodiment, the procedure includes a stimulative electrotherapy. According to one embodiment, the non-transitory computer-readable medium stores code for displaying the training aid including code for displaying on the graphical user interface the graphical representation, and code for receiving a selection of one of a multitude of locations on the graphical representation using the graphical user interface. The non-transitory computer-readable medium further stores code for accessing a description associated with the selection from a fifth database, code for displaying on the graphical user interface the description on the graphical user interface, and code for repeating displaying the graphical representation, receiving a selection, accessing a description, and displaying the description until an exit command is received.

According to one embodiment, the non-transitory computer-readable medium further includes code for displaying on the graphical user interface a multitude of icons associated with a multitude of graphical views of the graphical representation, and code for receiving a selection of one of the multitude of icons associated with the multitude of graphical views using the graphical user interface. The non-transitory computer-readable medium further stores code for displaying on the graphical user interface a selected one of the multitude of graphical views on the graphical user interface. According to one embodiment, the non-transitory computer-readable medium stores code for displaying the training aid further includes code for returning to receiving a selection of a training aid from a menu when an exit command is received.

According to one embodiment, the non-transitory computer-readable medium stores code for displaying the training aid including code for accessing at least one of the multitude of questions and at least one of the multitude of associated answers, and code for displaying on the graphical user interface the at least one of the multitude of questions on the graphical user interface. The non-transitory computer-readable medium further stores code for receiving an answer input using the graphical user interface, and code for determining when a last question is displayed based on a predetermined number of questions to be accessed from the second database. The non-transitory computer-readable medium further stores code for repeating when the last question is not displayed, accessing, displaying the at least one of the multitude of questions, receiving an answer input, and determining. According to one embodiment, the code for displaying the training aid further includes code for returning to receiving a selection of a training aid from a menu when the last question is displayed.

According to one embodiment, the non-transitory computer-readable medium stores code for displaying the training aid further includes code for displaying on the graphical user interface a multitude of icons associated with a multitude of training modes, and code for receiving a selection of one of the multitude of icons using the graphical user interface. According to one embodiment, the non-transitory computer-readable medium stores code for displaying the training aid further includes code for comparing the answer input with the at least one of the multitude of associated answers, and code for determining a comparison outcome based on comparing the answer input with the at least one of the multitude of associated answers. The comparison outcome is positive if the answer input equals the at least one of the multitude of associated answers. The comparison outcome is negative if the answer input does not equal the at least one of the multitude of associated answers. The non-transitory computer-readable medium further stores code for determining a number of positive or negative comparison outcomes, and code for displaying on the graphical user interface the number of positive or negative comparison outcomes.

According to one embodiment, the non-transitory computer-readable medium stores code for displaying the training aid further includes code for displaying on the graphical user interface the answer input and the at least one of the multitude of associated answers. According to one embodiment, the non-transitory computer-readable medium stores code for accessing the at least one of the multitude of questions and the at least one of the multitude of associated answers is done in a predetermined order. According to one embodiment, the non-transitory computer-readable medium stores code for accessing the at least one of the multitude of questions and the at least one of the multitude of associated answers is done in a random order to select a predetermined number of questions.

According to one embodiment, the non-transitory computer-readable medium stores code for displaying the training aid includes code for displaying on the graphical user interface a portion of the multitude of symptoms, and code for receiving a selected one of the portion of the multitude of symptoms using the graphical user interface. The non-transitory computer-readable medium further stores code for accessing one of the multitude of associated solutions based on the selected one of the portion of the multitude of symptoms, and code for displaying on the graphical user interface the one of the multitude of associated solutions. According to one embodiment, the non-transitory computer-readable medium stores code for displaying the training aid further includes code for returning to receiving a selection of a training aid from a menu after displaying the one of the multitude of associated solutions.

According to one embodiment, the non-transitory computer-readable medium stores code for displaying the training aid further includes code for displaying on the graphical user interface a multitude of icons associated with a multitude of display modes, and code for receiving a selection of one of the multitude of icons using the graphical user interface. According to one embodiment, the non-transitory computer-readable medium stores code for displaying the multitude of symptoms includes code for displaying on the graphical user interface a table of the portion of the multitude of symptoms until the selected one of the portion of the multitude of symptoms is received. According to one embodiment, the non-transitory computer-readable medium stores code for displaying the multitude of symptoms including code for displaying on the graphical user interface a graphical view related to the multitude of symptoms and stored in a fifth database, and code for receiving a selection of one of a multitude of locations on the graphical view using the graphical user interface. The selection is associated with the selected one of the portion of the multitude of symptoms.

According to one embodiment, the non-transitory computer-readable medium stores code for displaying the training aid includes code for displaying on the graphical user interface one of the multitude of sequences, and code for determining when a last one of the multitude of sequences is displayed based on a predetermined number of sequences. The non-transitory computer-readable medium further stores code for repeating displaying one of the multitude of sequences, and determining when the last one of the multitude of sequences is not displayed. According to one embodiment, the non-transitory computer-readable medium stores code for displaying the training aid further includes code for returning to receiving a selection of a training aid from a menu when the last one of the multitude of sequences is displayed

According to one embodiment, the non-transitory computer-readable medium stores code for displaying one of the multitude of sequences includes code for displaying a text of one of the multitude of sequences. According to one embodiment, the non-transitory computer-readable medium stores code for displaying one of the multitude of sequences includes code for displaying a video of one of the multitude of sequences. According to one embodiment, the non-transitory computer-readable medium stores code for displaying one of the multitude of sequences includes code for displaying a text of one of the multitude of sequences, and code for displaying a video of one of the multitude of sequences.

According to one embodiment, the non-transitory computer-readable medium stores code for registering the profile of the user includes code for accessing the profile from a fifth database storing the profile of the user, and code for displaying on the graphical user interface the profile, code for editing the profile using the graphical user interface. The non-transitory computer-readable medium further stores code for storing the profile in the fifth database when the editing is completed. According to one embodiment, the non-transitory computer-readable medium stores code for registering a profile of the user further includes code for returning to receiving a selection of a training aid from a menu when the storing is completed.

According to one embodiment, the non-transitory computer-readable medium stores code for displaying the training aid includes code for accessing an email address from the profile from a fifth database storing the profile of the user, code for composing an email to an entity associated with the procedure, and code for sending the email to the entity. According to one embodiment, the non-transitory computer-readable medium stores code for registering a profile of the user further includes code for returning to receiving a selection of a training aid from a menu when the sending is completed.

According to one embodiment of the present invention, a non-transitory computer-readable medium stores computer-executable code for training a user in a procedure. The non-transitory computer-readable medium includes code for registering a profile of the user, code for receiving a selection of a training aid from a menu using a graphical user interface of the computer, and code for displaying the training aid on the graphical user interface of the computer. The training aid is responsive to an input from the user. The training aid accesses a storage space of the computer including a first database storing a graphical representation associated with the procedure, and a second database storing a multitude of questions and a multitude of associated answers. The multitude of questions is associated with the procedure. The storage space of the computer further includes a third database storing a multitude of symptoms and a multitude of associated solutions, the multitude of symptoms being associated with the procedure, and a fourth database storing a multitude of sequences associated with the procedure. When the selection is a first selection, the code for displaying the training aid includes code for accessing at least one of the multitude of questions and at least one of the multitude of associated answers, and code for displaying on the graphical user interface the at least one of the multitude of questions on the graphical user interface. The code for displaying the training aid further includes code for receiving an answer input using the graphical user interface, code for determining when a last question is displayed based on a predetermined number of questions to be accessed from the second database. The code for displaying the training aid further includes code for repeating when the last question is not displayed, accessing, displaying the at least one of the multitude of questions, receiving an answer input, and determining. When the selection is a second selection, the code for displaying the training aid includes code for displaying on the graphical user interface a portion of the multitude of symptoms, and code for receiving a selected one of the portion of the multitude of symptoms using the graphical user interface. The code for displaying the training aid further includes code for accessing one of the multitude of associated solutions based on the selected one of the portion of the multitude of symptoms, and code for displaying on the graphical user interface the one of the multitude of associated solutions.

A better understanding of the nature and advantages of the embodiments of the present invention may be gained with reference to the following detailed description and the accompanying drawings.

### DESCRIPTION OF THE DRAWINGS

FIG. 1 depicts a simplified block diagram of a patient testing theatre, in accordance with one embodiment of the present invention.

FIG. 2A depicts a simplified flow chart of a computer-implemented method for training a user in a procedure, in accordance with one embodiment of the present invention.

FIG. 2B depicts an example of a user interface for accepting terms of a disclaimer, in accordance with one embodiment of the present invention.

FIG. 2C depicts an example of a user interface for registering a user, in accordance with one embodiment of the present invention.

FIG. 2D depicts an example of a user interface for selecting a training mode, in accordance with one embodiment of the present invention.

FIG. 3A depicts a simplified, flow chart of a computer-implemented method for an ear map mode represented in FIG. 2A, in accordance with one embodiment of the present invention.

FIG. 3B depicts an example of a user interface for displaying a western ear map of a multitude of autonomic nervous system sensitivity-points, in accordance with one embodiment of the present invention.

FIG. 3C depicts an example of a user interface for displaying a description of a selected location on an eastern ear map of autonomic nervous system sensitivity-points, in accordance with one embodiment of the present invention.

FIG. 4A depicts a simplified, flow chart of a computer-implemented method for an learn/test mode represented in FIG. 2A, in accordance with one embodiment of the present invention.

FIG. 4B depicts an alternative example of a user interface for selecting a training mode, in accordance with one embodiment of the present invention.

FIG. 4C depicts an example of a user interface for answering a question in a learn mode, in accordance with one embodiment of the present invention.

FIG. 4D depicts an example of a user interface for displaying an answer to the question represented in FIG. 4C, in accordance with one embodiment of the present invention.

FIG. 4E depicts an example of a user interface for answering a question in a test mode, in accordance with one embodiment of the present invention.

FIG. 4F depicts an example of a user interface for displaying a test result in a test mode, in accordance with one embodiment of the present invention.

FIG. 5A depicts a simplified, flow chart of a computer-implemented method for a clinical guidance mode represented in FIG. 2A, in accordance with one embodiment of the present invention.

FIG. 5B depicts an example of a user interface for displaying a back body view in a display graphics mode, in accordance with one embodiment of the present invention.

FIG. 5C depicts an example of a user interface for displaying a multitude of symptoms in a table, in accordance with one embodiment of the present invention.

FIG. 5D depicts an example of a user interface for displaying electrotherapy needle locations on the ear, in accordance with one embodiment of the present invention.

FIG. 6A depicts a simplified, flow chart of a computer-implemented method for a step by step treatment mode represented in FIG. 2A, in accordance with one embodiment of the present invention.

FIG. 6B depicts an example of a user interface for displaying static instructional text, in accordance with one embodiment of the present invention.

FIG. 6C depicts an example of a user interface for displaying an instructional video, in accordance with one embodiment of the present invention.

FIG. 7A depicts a simplified, flow chart of a computer-implemented method for an update registration profile mode represented in FIG. 2A, in accordance with one embodiment of the present invention.

FIG. 7B depicts an example of a user interface for updating the user registration, in accordance with one embodiment of the present invention.

FIG. 7C depicts an example of a user interface for completing the user registration update, in accordance with one embodiment of the present invention.

FIG. 8 depicts a simplified, flow chart of a computer-implemented method for purchase product mode represented in FIG. 2A, in accordance with one embodiment of the present invention.

FIG. 9 depicts a simplified block diagram of a computer system that may incorporate embodiments of the present invention.

### DETAILED DESCRIPTION

In accordance with one embodiment of the present invention, the disclosure relates generally to a computer-implemented method for training a user in a procedure. The procedure may be related to any type of field that would benefit from an integrated teaching solution where text, video, self-paced learning, testing, and automated reporting capabilities are of benefit. For example, a technician may learn how to use or repair a piece of equipment, be qualified for that procedure and then inform a supervisor of completing the qualification via an automated email. In another example, a medical practitioner may be taught a procedure to use a new medical device and then contact a manufacturer of that device to purchase the device. The disclosure will been described with reference to teaching a procedure for treating a human patient with auricular acupuncture electrotherapy by way of an example, it is understood that the invention is not limited by the type of procedure. The following short description provides context for the electrotherapy treatment procedure.

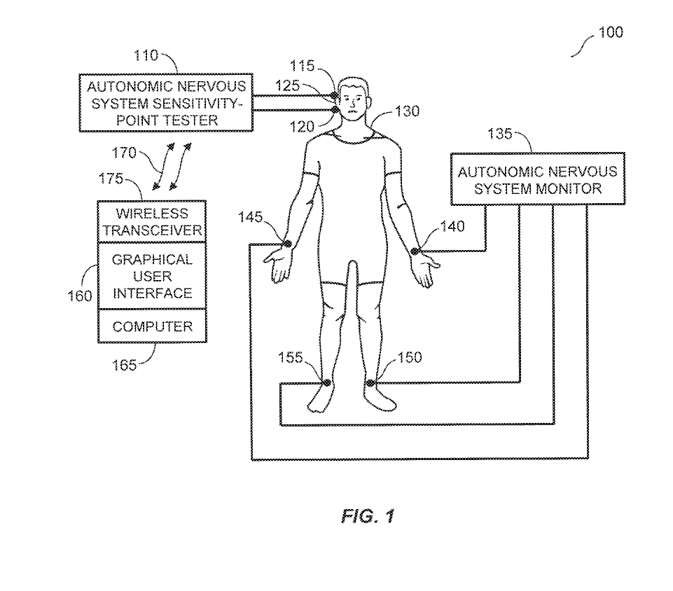

FIG. 1 depicts a simplified block diagram of a patient testing theatre, in accordance with one embodiment of the present invention. Patient testing theatre 100 includes an autonomic nervous system sensitivity-point tester 110 coupled to an electrically conductive tip 115 and an electrode 120, which in-turn are connected to an ear 125, hereinafter also referred to as “portion of skin”, of a patient 130. In one embodiment, an autonomic nervous system monitor 135 is coupled to electrodes 140, 145, 150, 155 respectively on the patient's left arm, right arm, left leg, right leg to receive quasi-periodical electro cardiogram signals from the cardiac system that are in-turn governed by the patient's autonomic nervous system. The patient is preferably in a supine position on an examination table in a clinical environment for autonomic nervous system testing and monitoring.

In the exemplary embodiment depicted in FIG. 1, the patient is represented as a human. It is understood, however, that the patient may be any living creature possessing an autonomic nervous system and cardiac system. In the exemplary embodiment depicted in FIG. 1, autonomic nervous system sensitivity-point tester 110 is shown as connecting to an ear. It is understood, however, that autonomic nervous system sensitivity-point tester 110 may instead be connected to any portion of skin demonstrated to have nerve connections sensitive enough to affect the autonomic nervous system of the patient.

In one embodiment, the patient testing theatre 100 may include a graphical user interface 160 coupled to a computer 165, which may be coupled via cable (not shown) or via wireless radio transmission 170 to autonomic nervous system sensitivity-point tester 110. Preferably, the autonomic nervous system sensitivity-point tester is a wireless hand held device, which may be programmed or have certain characteristics set by a medical practitioner or technician (not shown) via graphical user interface 160 and computer 165. In one embodiment, computer 165 may be a desktop, laptop, pad, mini-pad, or smart phone that may have a wireless transceiver 175.

The autonomic nervous system monitor 135 is adapted to convert the patient's electro cardiogram signals to, among other information, a sympathovagal balance between the parasympathetic and the sympathetic components of the autonomic nervous system. U.S. Pat. No. 7,092,849 to Lafitte, et al. and co-pending U.S. patent, titled “STIMULATIVE ELECTROTHERAPY USING AUTONOMIC NERVOUS SYSTEM CONTROL” to Nageshwar, which are incorporated by reference, describe, in part, the theory of operation for autonomic nervous system monitor 135.

In one embodiment, a locator application running on computer 165 is used to generally determine the needle locations for the auricular acupuncture electrotherapy. In other words, choosing a first portion of the patient's skin is done by obtaining a preliminary skin location, e.g. on the ear, from graphical user interface 160 coupled to computer 165 executing a program responsive to a symptom of the patient. For example, the patient may be presenting to the medical practitioner with symptoms of a pain in the lower back. The medical practitioner may select that symptom on graphical user interface 160, which responds by displaying the general location on a map of the ear, where acupuncture electrotherapy has been associated with lower back pain treatment.

As described above the procedure associated with acupuncture electrotherapy involves several devices and special knowledge that may not be commonly known in the medical profession. Therefore, a computer-implemented method for training a medical professional in the acupuncture electrotherapy procedure, before the devices are purchased, would be of benefit as it may enable the medical professional to perform the procedure without first learning acupuncture.

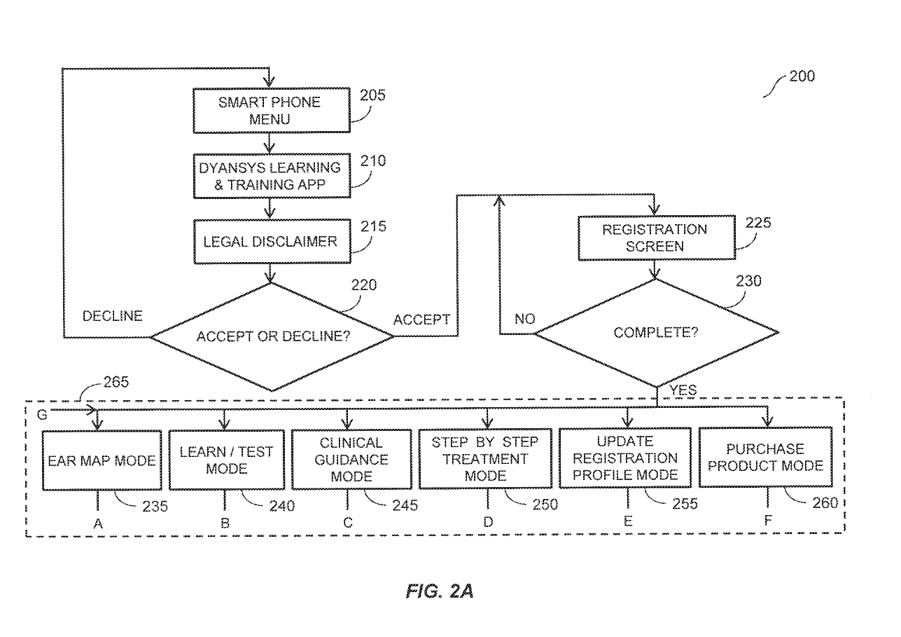

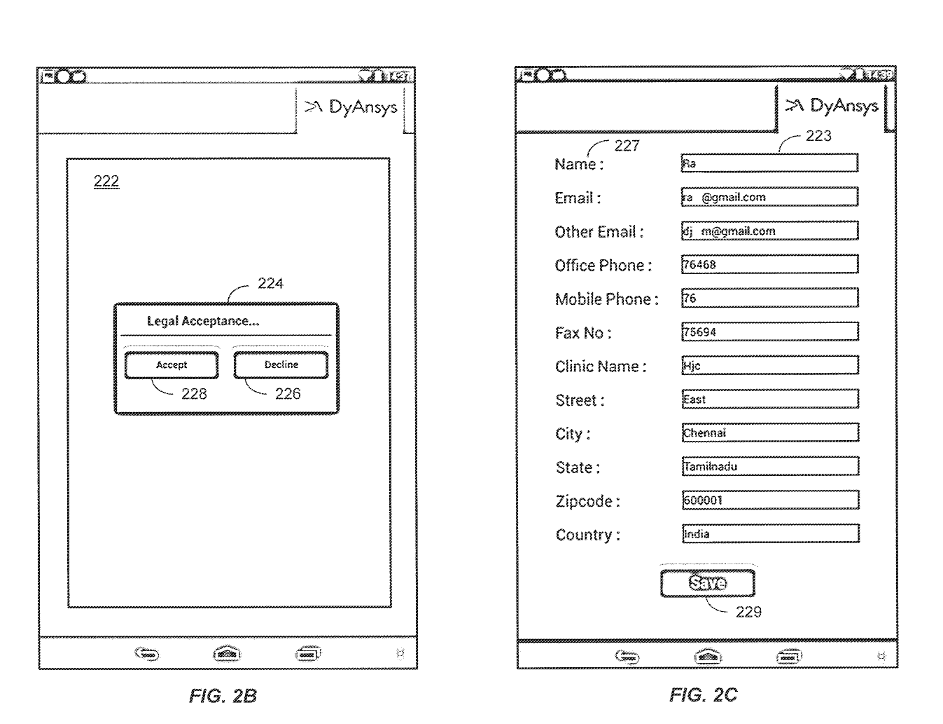

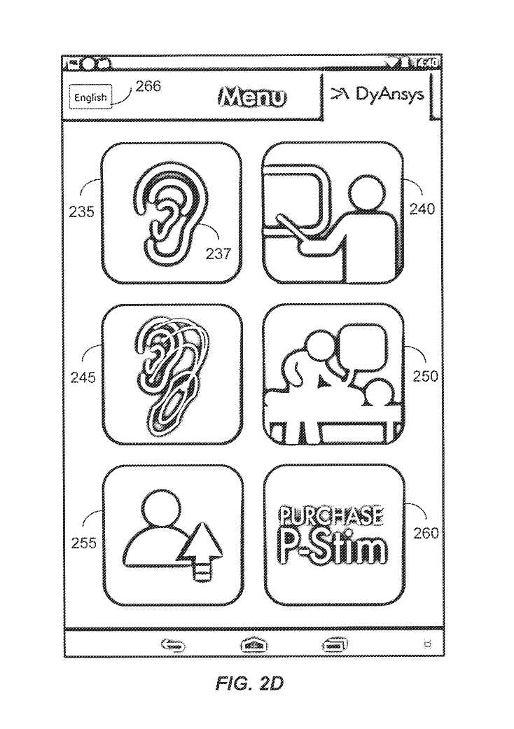

FIG. 2A depicts a simplified flow chart of a computer-implemented method for training a user in a procedure 200, hereinafter also referred to as “training app”, in accordance with one embodiment of the present invention. By way of example, training app 200 is shown implemented on a smart phone computer system including a touch sensitive display screen as the computer system's graphical user interface, hereinafter also referred to as “screen”. A user, such as a student or medical practitioner, selects 205 training app 200 from the smart phone's menu by touching an icon displayed on the menu screen of the smart phone, which launches 210 training app 200 and displays 215 the text for a legal disclaimer. For example, because the procedure in this example is a medical one, the medical practitioner takes responsibility and the training app emphasizes that it only provides guidance and the inventor of the training app assumes no medical liability. In another example, the legal disclaimer may warn the user of not operating a machine under certain conditions. In one embodiment, text for terms of use may be displayed in the legal disclaimer.

The user then accepts or declines 220 the legal disclaimer. FIG. 2B depicts an example of a user interface for accepting terms of the legal disclaimer, in accordance with one embodiment of the present invention. Text 222, represented simply as a rectangular area in FIG. 2B, of the legal disclaimer may be displayed behind a legal acceptance window 224 in the foreground displaying an accept icon 228 and a decline icon 226, which are activated by user touch.

Referring to FIG. 2A, when the user declines, the training app returns the user to the smart phone's menu selections 205. If the user accepts the legal disclaimer, a registration screen is displayed 225 for registering, with the one or more processors associated with the computer, a profile of the user. The profile may include personal information of the user such as name, address, phone number, email address, identification number, and the like. FIG. 2C depicts an example of a user interface for registering the user, in accordance with one embodiment of the present invention. A multitude of information fields 223 are displayed to the right of a multitude of associated descriptive text lines 227. Touching a field brings up a touch typing display for the user to fill in the date for that field. When a predetermined number of required fields are filled-in, the user may complete the registration by touching the save icon 229.

Referring to FIG. 2A, when the user completes 230 the registration by filing in the required information fields, training app 200 displays 265 (flowchart reference G) a menu on the screen including icons for selecting or launching one of a multitude of associated training modes, hereinafter also referred to as “training aids”. FIG. 2D depicts an example of a user interface for selecting the training mode, in accordance with one embodiment of the present invention. Referring simultaneously to FIG. 2A and FIG. 2D, in one embodiment, training app 200 may display 265 icons for associated training aids including any combination of; an ear map mode 235, a learn/test mode 240, a clinical guidance mode 245, a step by step treatment mode 250, an update registration profile mode 255, and/or a purchase product mode 260 associated with respective flowchart references A, B, C, D, E, F. The icons may show simple graphical representations associated with each mode to help identification. For example, the icon for ear map mode 235 may show a stylized symbol representing an ear 237.

When the user selects by touching the screen over one of the multitude of icons at display 265, the one or more processors receives that selection and starts the code for the selected training aid module. The selected training aid is then displayed on the screen, with the one or more processors. The selected training aid may access, with the one or more processors, a storage space of the computer, which may include a multitude of databases associated with the procedure. The selected training aid may be responsive to an input from the user as will be described in detail below. For example, the user may select a display language 266 from a predetermined multitude of languages stored in the training app.

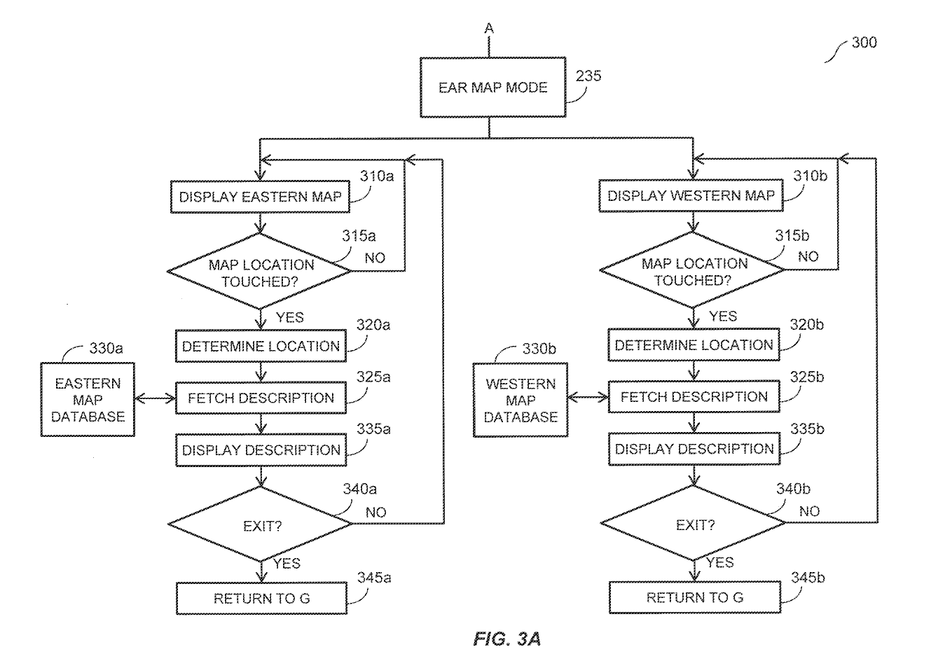

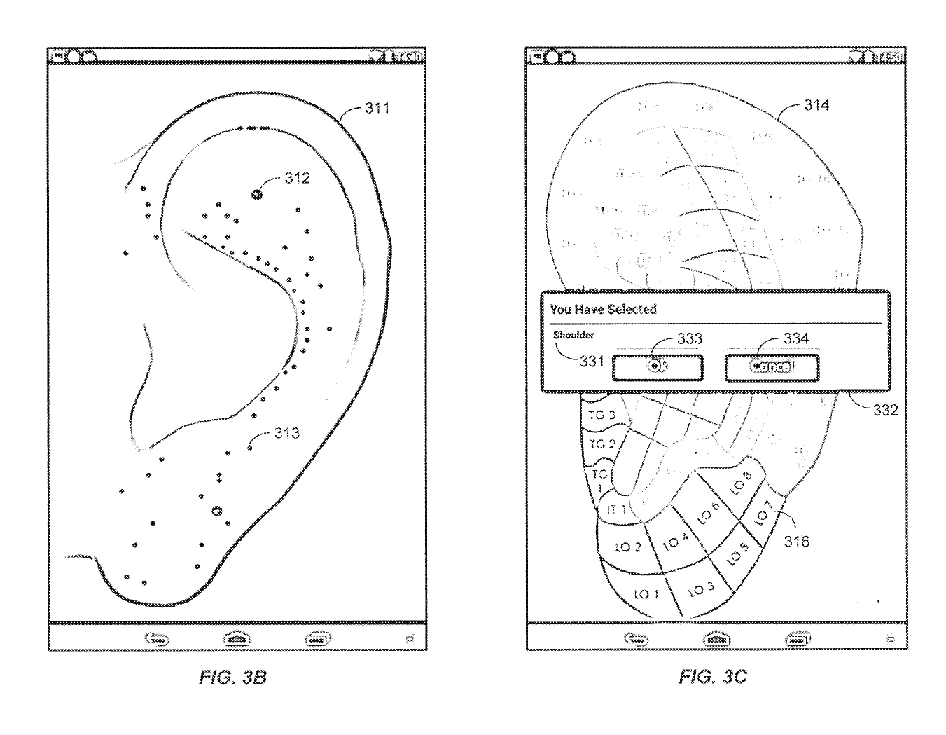

FIG. 3A depicts a simplified, flow chart of a computer-implemented method for an ear map mode 300 represented in FIG. 2A, in accordance with one embodiment of the present invention. Referring to FIG. 3A, when the ear map mode is selected 235 by the user, a graphical representation associated with the procedure may be displayed on the screen with the one or more processors. The graphical representation may be stored in a first, e.g. map, database of the storage space of the computer. In one embodiment, the screen displays, with the one or more processors, a multitude of icons associated with a multitude of graphical views of the graphical representation, similar to FIG. 2B with the exception that the icons identify the associated multitude of graphical views. When the user touches the screen above one of the multitude of icons associated with the multitude of graphical views, the one or more processors receive that selection and display the selected one of the multitude of graphical views on the screen.

In one example, the graphical representation may include a portion of an anatomy of a patient such as a portion of skin surface. Referring to FIG. 3A, in one embodiment, the screen may display a pair of icons for selecting the display 310a, 310b of a map of the ear locations for acupuncture electrotherapy based on eastern medicine or western medicine procedures, respectively. FIG. 3B depicts an example of a user interface for displaying 310b western ear map 311 of a multitude of autonomic nervous system sensitivity-points 312, 313 mapped on ear 311, in accordance with one embodiment of the present invention. In another example, engineering views of a work-piece associated with the procedure may be displayed based on selection of top, side, or end views, and the like.

The graphical representation may include a multitude of user selectable locations on the graphical representation. In other words, the displayed graphical view may be responsive to an input from the user. Referring to FIG. 3A, the graphical representation will continue to be displayed until the user touches 315a, 315b the screen over one of the locations. Then, the one or more processors, receive that selection, determine the location 320a, 320b, access or fetch 325a, 325b a description associated with the selected location from a database 330a, 330b and display 335a, 335b that description on the screen.

FIG. 3C depicts an example of a user interface for displaying 335a a description 331 of a selected location on an eastern ear map 314 of autonomic nervous system sensitivity-points 316, in accordance with one embodiment of the present invention. Eastern ear map 314 may be displayed behind a smaller window 332 displayed in the foreground that displays description 331, an OK icon 333, and a cancel icon 334, which are activated by user touch. Referring simultaneously to FIG. 3A and FIG. 3C, the one or more processors, may repeat displaying the graphical representation, receiving a selection, accessing a description, and displaying the description by activating OK icon 333 until an exit command, i.e. activating cancel icon 334, is received 340a, 340b. When an exit command is received, the one or more processors, exit the ear map mode and return 345a, 345b to reference point G in the method, i.e. displaying the training aid selection menu.

For example, the user may touch 315a, 315b the screen at a location over the displayed ear and observe on the screen a display 335a, 335b of a description 331 of a symptom that may be associated with that location, which may be close to a point for needle insertion for the electrotherapy treatment of that symptom. In the above example, the graphical representation was the same, i.e. an ear, however the description was based on the user's selection of symptoms treated with a neuro-stimulative electrotherapy based on either a western medicine protocol 310b-345b or an eastern medicine protocol 310a-345a. In another example, the user may obtain a description of the function of a certain portion of a work-piece displayed in graphical representation on a selected engineering view. In another example, the description may be selected to a user experience level such as engineer, technician, or factory operator, and the like.

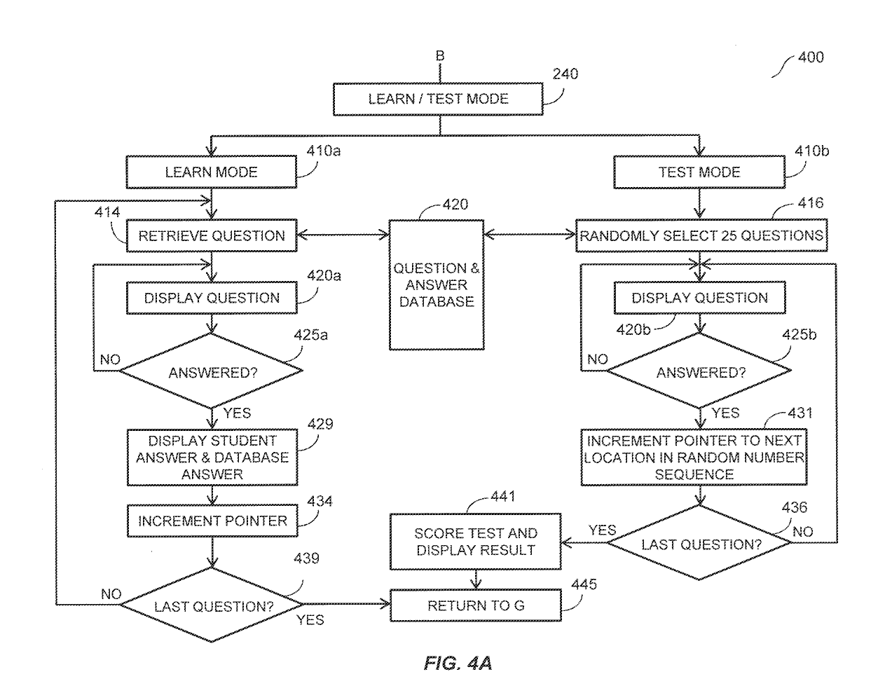

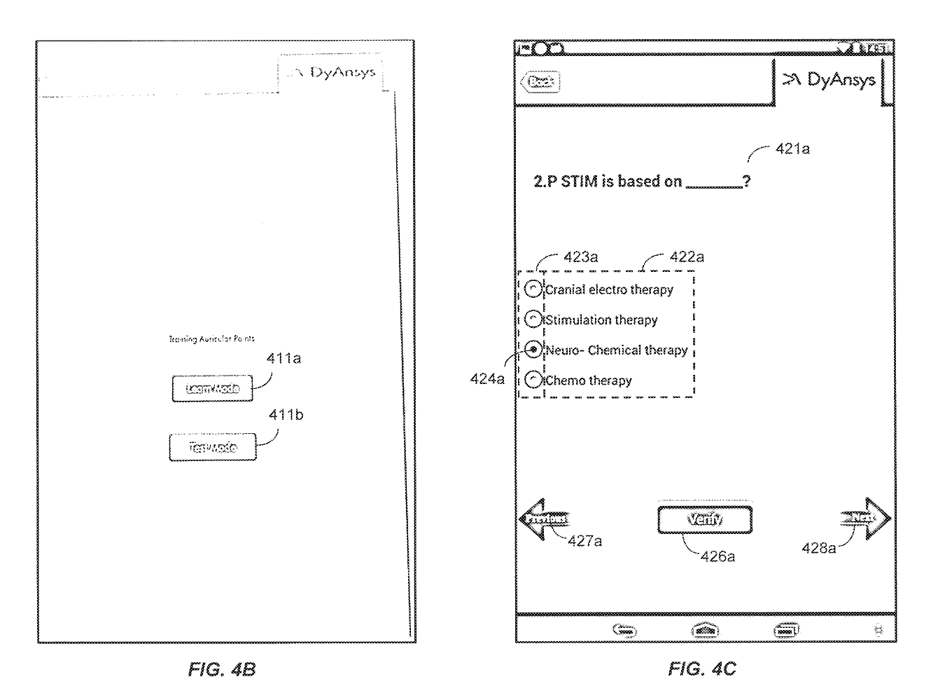

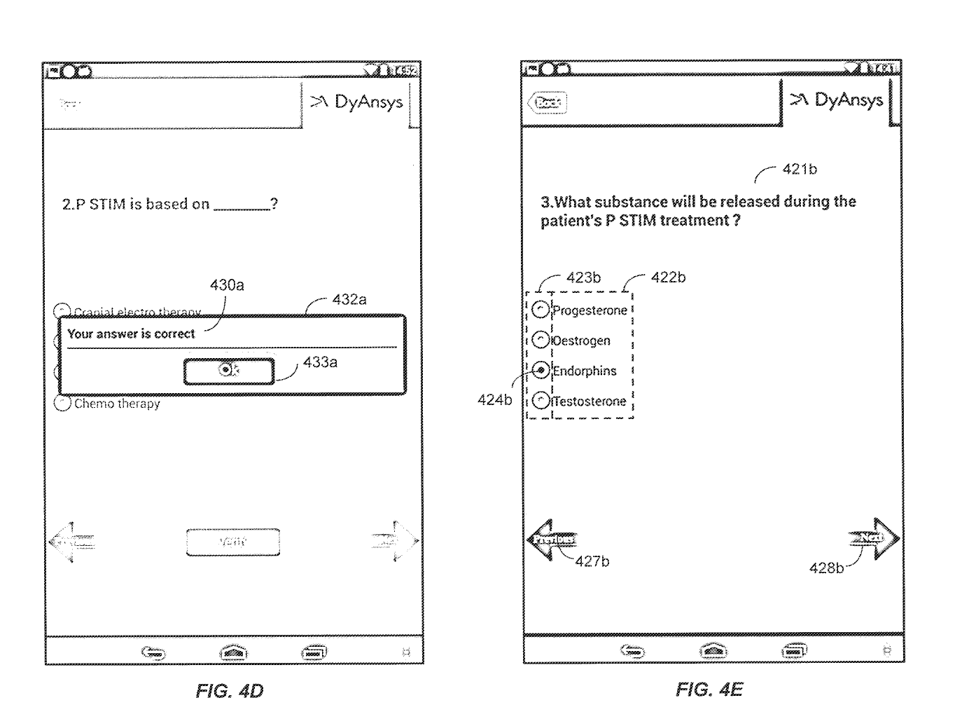

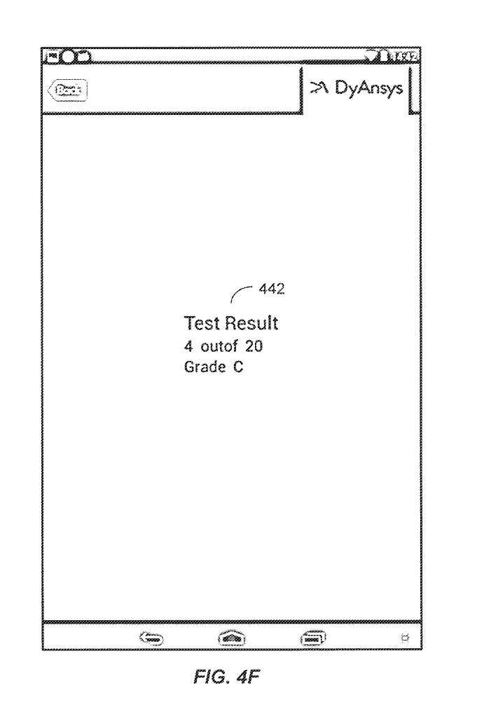

FIG. 4A depicts a simplified, flow chart of a computer-implemented method for an learn/test mode 400 represented in FIG. 2A, in accordance with one embodiment of the present invention. Referring to FIG. 3A, when the learn/test mode is selected 240 by the user, the one or more processors, display on the screen a multitude of icons associated with a multitude of training modes. In one embodiment, the multitude of training modes may include a learn mode 410a and a test mode 410b. When the user touches the screen above one of the multitude of icons associated with the multitude of training modes, the one or more processors receive that selection and access 414, 416 at least one of the multitude of questions and at least one of the multitude of associated answers stored in a database 420. The questions are associated with the procedure. The one or more processors then display 420a, 420b the first of the multitude of questions on the screen. The user then inputs and enters 425a, 425b the answer to the question via the graphical user interface, whereupon the one or more processors, receive the answer input.

In one embodiment, the way the processor(s) access the database and respond to the user's answer is based upon which training mode is selected by the user. FIG. 4B depicts an alternative example of a user interface for selecting a training mode, in accordance with one embodiment of the present invention. FIG. 4B is similar to FIG. 2B except FIG. 4B depicts the display of two icons one above the other instead of side by side, whose activation by user touch provides the selection of the training modes.

Referring simultaneously to FIG. 4A and FIG. 4B, in one embodiment, when the user selects learn mode 410a by touching icon 411a, the one or more processors may retrieve or access 414 the at least one of the multitude of questions and the at least one of the multitude of associated answers in a predetermined order chosen to teach the procedure efficiently. For example, the predetermined order may be sequential. FIG. 4C depicts an example of a user interface for answering a question 421a in a learn mode, in accordance with one embodiment of the present invention. The answer may be selected from a multiple choice list 422a of a multitude of possible answers via an associated multitude of radio icon buttons 423a. When the user touches one of the multitude of radio icon buttons 423a, the display of a selected button 424a is changed indicating the selection of the user's answer. The user may browse the questions by touching previous icon 427a or next icon 428a, changing previous answers if so desired or skipping difficult questions.

Referring simultaneously to FIG. 4A and FIG. 4C, after question 421a is answered 424a, 425a by the user in learn mode, the one or more processors, display 429 on the screen the answer input and the at least one of the multitude of associated answers on the screen, after the user touches verify icon 426a. FIG. 4D depicts an example of a user interface for displaying an answer 430a to question 421a represented in FIG. 4C, in accordance with one embodiment of the present invention. In FIG. 4D, multiple choice list 422a of a multitude of possible answers may be displayed behind a smaller answer window 432a in the foreground displaying answer 430a and an OK icon 433a, which is activated by user touch. Alternatively (not shown), multiple choice list 422a of a multitude of possible answers may be displayed beside a smaller answer window 432a displaying answer 430a and OK icon 433a. The user may then compare how close their answer input is to the “correct” answer stored in the database. Referring simultaneously to FIG. 4A and FIG. 4D, after the user touches OK icon 433a, an address pointer associated with the question and answer database is incremented 434 with the one or more processors, which then determine 439 when a last question is displayed based on a predetermined number of questions to be accessed from the second, i.e. question and answer, database.

Referring to FIG. 4A, in one embodiment, the predetermined number of questions to be accessed in the learn mode may be equal to the total number of questions stored in the second database. In another embodiment, the predetermined number of questions to be accessed in the learn mode may be equal to a portion of the total number of questions stored in the second database. When the last question is not displayed, the one or more processors repeat; accessing, displaying the at least one of the multitude of questions, receiving an answer input, and determining when the last question is displayed. When the last question is displayed, the one or more processors, exit the learn mode and return 445 to reference point G in the method, i.e. displaying the training aid selection menu.

In contrast, when the user selects test mode 410b, the one or more processors may retrieve or access 416 the at least one of the multitude of questions and the at least one of the multitude of associated answers in a random order from the second database chosen to select a predetermined number of questions. For example, the predetermined number of questions may be twenty-five or any other number based on test difficulty. FIG. 4E depicts an example of a user interface for answering a question 421b in a test mode, in accordance with one embodiment of the present invention. FIG. 4E depicts the same functions as FIG. 4C indicated by the similar reference numbers except ending in “b” instead of “a” and the verify icon is removed so that all the predetermined number of questions are answered to test the users knowledge.

Referring to FIG. 4A, after the question is answered by the user in test mode, an address pointer associated with the predetermined number of randomly chosen questions and associated answers is incremented 431 with the one or more processors, which then determine 436 when a last question is displayed based on the predetermined number of questions to be accessed from the second database. When the last question is not displayed, the one or more processors repeat displaying the at least another one of the multitude of questions, receiving an answer input, and determining when the last question is displayed.

In one example, the questions may be associated with a treatment of a dysfunction of a patient. The treatment may be based on stimulative electrotherapy. In another example the questions may be associated with finding a solution to a malfunction of a machine.

In test mode, after the last question is displayed, in one embodiment the one or more processors score 441 the test by comparing the answer input with the at least one of the plurality of associated “correct” answers stored in database 420 for each question displayed earlier. The one or more processors, determine a comparison outcome based on comparing the answer input with the at least one of the multitude of associated answers. The comparison outcome may be positive if the answer input equals the at least one of the multitude of associated answers. The comparison outcome may be negative if the answer input does not equal the at least one of the multitude of associated answers. The one or more processors determine a number of positive or negative comparison outcomes, i.e. add up the score, and display on the screen the number of positive or negative comparison outcomes. FIG. 4F depicts an example of a user interface for displaying a test score or result 442 in a test mode, in accordance with one embodiment of the present invention. Referring to FIG. 4A, after the test is scored, the one or more processors, exit the test mode and return 445 to reference point G in the method, i.e. displaying the training aid selection menu.

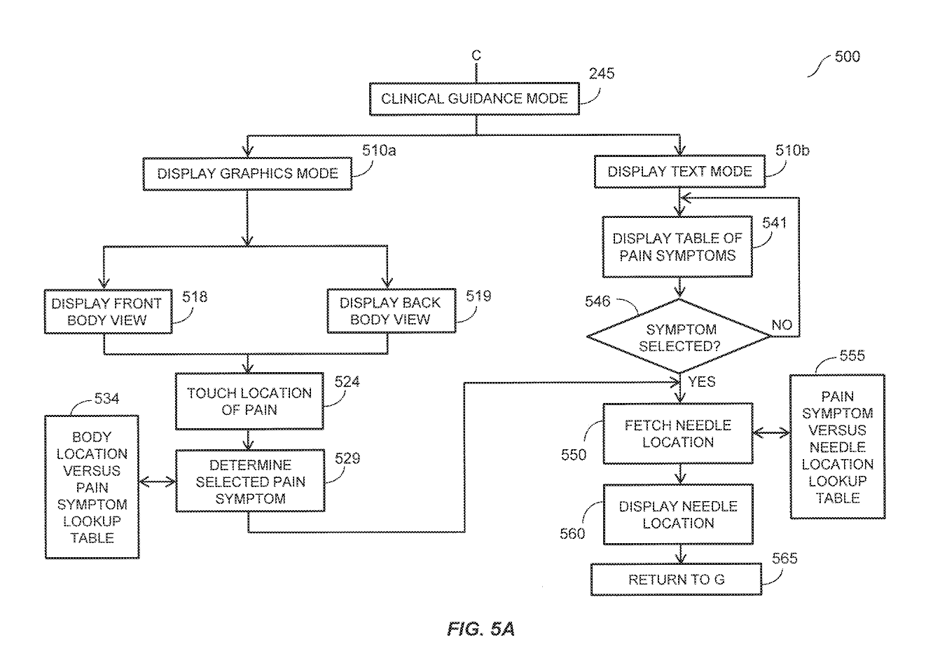

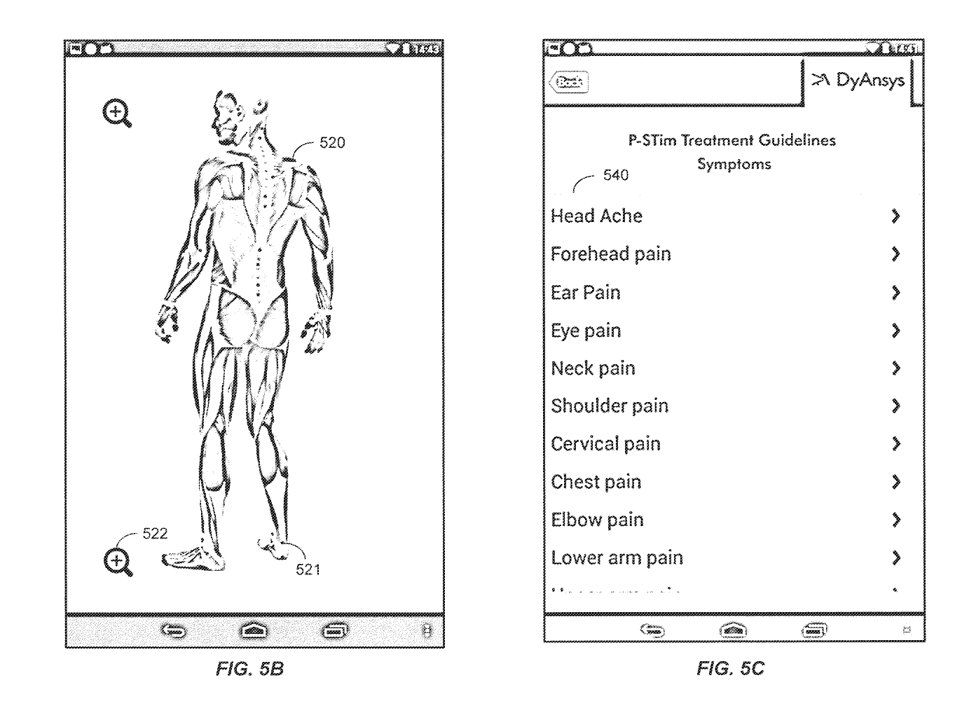

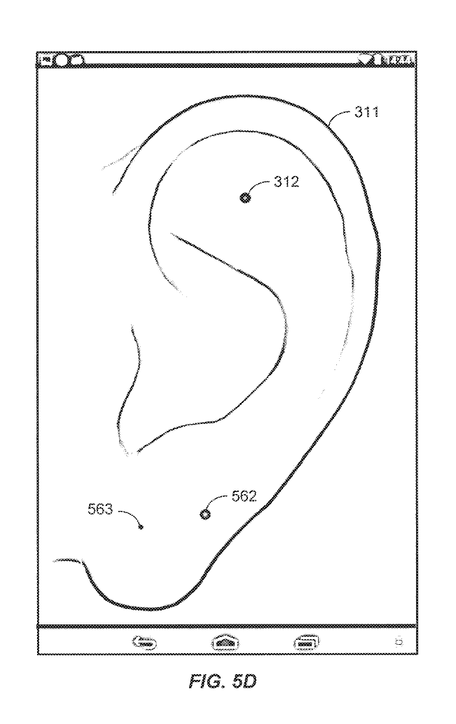

FIG. 5A depicts a simplified, flow chart of a computer-implemented method for a clinical guidance mode 500 represented in FIG. 2A, in accordance with one embodiment of the present invention. In ear map mode described in reference to FIG. 2A and FIG. 3A, a symptom is displayed against a graphical representation of the site where the treatment or solution is to be done. For example, an ear is displayed and the user selects a location on the ear to access what symptom in the patient is treated at that ear location. In another example, a graphic representation of a control panel for a machine may be displayed and touching a location of a button on the panel may display what part of the machine is controlled by that button. In contrast, clinical guidance mode first displays a choice of symptoms or malfunctions and then displays the treatment or solution location. For example, a graphic representation of the machine is displayed and touching a location of the machine may display a graphic representation of the button on the control panel that controls the previously touched part of the machine.

When the clinical guidance mode is selected 245 by the user, the one or more processors, display on the screen a multitude of icons associated with a multitude of display modes, similar to FIG. 2B with the exception that the icons identify the associated multitude of display modes. Referring to FIG. 5A, in one embodiment, the multitude of display modes may include a display graphics mode 510a and a display text mode 510b. When the user touches the screen above one of the multitude of icons associated with the multitude of display modes, the one or more processors receive that selection.

When the user selects display graphics mode 510a, the one or more processors, display on the screen a multitude of icons associated with a multitude of graphical views. In one embodiment, the multitude of graphical views may include a portion of an anatomy of a patient such as a display front body view 518 and a display back body view 519 stored in a database 534, which may include a body location versus pain symptom lookup table. When the user touches the screen above one of the multitude of icons associated with the multitude of graphical views, the one or more processors receive that selection, access database 534, and display on the screen the selected one of the multitude of graphical views.

FIG. 5B depicts an example of a user interface for displaying a back body view 520 in a display graphics mode, in accordance with one embodiment of the present invention. The selected one of the multitude of graphical views is related to the multitude of symptoms associated to a multitude of locations 521 on the graphical view. In other words the processor(s) display on the screen a portion of the plurality of symptoms associated or embedded with the locations on the graphical view. The graphical view may be manipulated by the user on the screen. For example, touching magnify button 522 may magnify the view to better resolve multitude of locations 521. Referring simultaneously to FIG. 5A and FIG. 5B, when the user touches 524 the screen above one of the multitude of locations 521 on the graphical view, the one or more processors receive that selection and determine 529 the selected pain symptom from the body-location versus pain-symptom lookup table 534. In other words, the one or more processors, receive a selected one of the portion of the multitude of symptoms that were displayed on the screen and associated with the selected location.

Referring to FIG. 5A, when the user selects display text mode 510b, the one or more processors, display 541 on the screen a table of the portion of the multitude of symptoms until the user selects 546 one of the multitude of symptoms. The portion may include all symptoms in one list, may include scrolling to view sections of the list at a time, or may include a subset of the multitude of symptoms. FIG. 5C depicts an example of a user interface for displaying a multitude of symptoms in a table 540, in accordance with one embodiment of the present invention. A portion of the table is displayed on the screen at a time. The table may scroll to access other portions of the table. When the user touches the screen above one of the multitude of symptoms, the one or more processors receive that selection.

Referring to FIG. 5A, after the symptom has been selected by the user with one of the display modes, e.g. graphically or via text, the one or more processors, access 550 or fetch one of the multitude of associated solutions. Access 550 or fetch of the solution is based on the selected one of the portion of the multitude of symptoms via a database 555 storing a multitude of symptoms and a multitude of associated solutions. For example, the solution may be an electrotherapy-needle insertion-location. The multitude of symptoms may be associated with the procedure. For example, database 555 may include the pain symptom versus needle location look up table. The one or more processors, display 560 on the screen the one of the multitude of associated solutions, e.g. needle location on a graphical representation of the ear. In one embodiment, more than one needle location may be displayed. After the solution is displayed, the one or more processors, exit the clinical guidance mode and return 565 to reference point G in the method, i.e. displaying the training aid selection menu. FIG. 5D depicts an example of a user interface for displaying electrotherapy needle locations 312, 562, 563 on ear 311, in accordance with one embodiment of the present invention. Location 563 may be associated with a specific symptom, while locations 312, 562 may be associated with general pain relief.

In one example, one of the multitude of symptoms may be associated with a dysfunction of a patient. The multitude of associated solutions are associated with a multitude of locations on the skin of the patient associated with a stimulative electrotherapy. In another example, the symptoms may be the operating modes of a machine and the solutions are the controls associated with the operating modes. In another example, the symptoms may be malfunctions of the machine and the solutions are locations on the machine that fix the associated malfunctions.

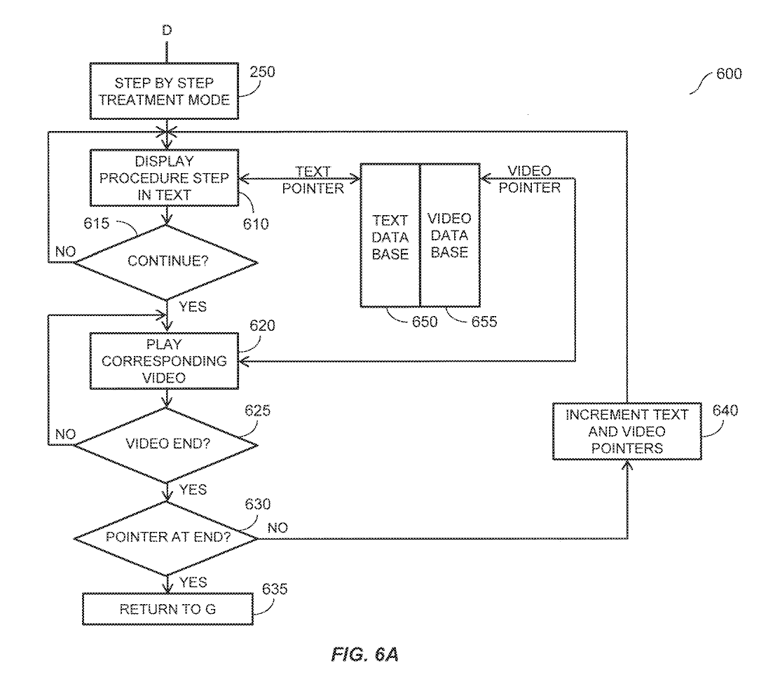

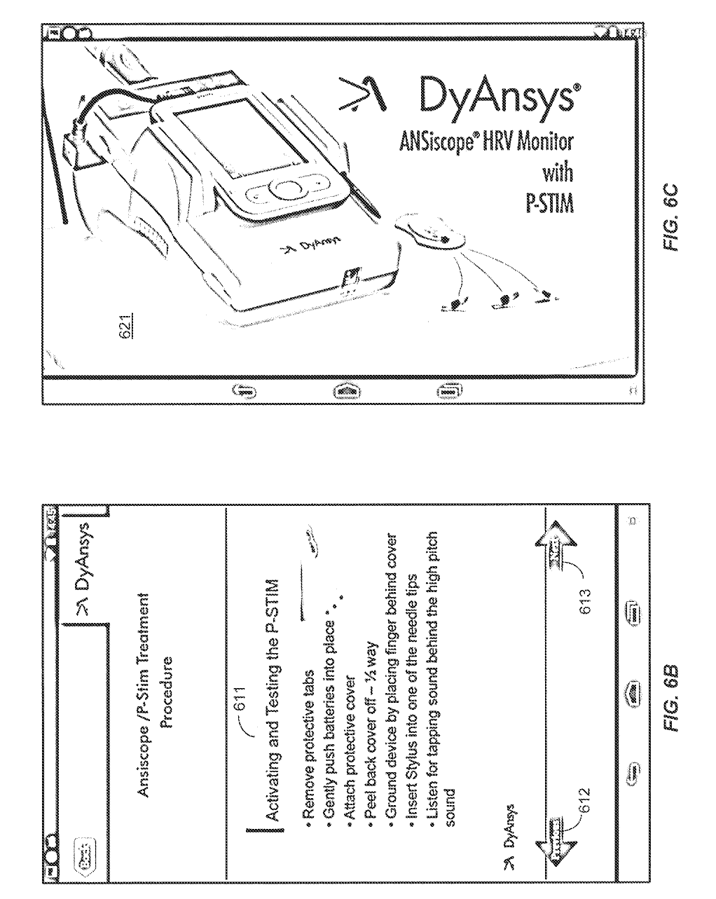

FIG. 6A depicts a simplified, flow chart of a computer-implemented method for a step by step treatment mode 600 represented in FIG. 2A, in accordance with one embodiment of the present invention. Referring to FIG. 6A, when the step by step treatment mode is selected 250 by the user, the one or more processors display 610, 620 on the screen one of the multitude of sequences associated with the procedure and stored in a database 650, 655. The sequences may include a single step of the procedure or a multitude of steps depending on the complexity of each step. The sequences may be in text or video format and may be displayed on the screen in any combination. In one embodiment, the plurality of sequences may be displayed in a predetermined order providing a complete description of the procedure from its beginning to its end.

In one embodiment, one or more processors first display 610 a text of one of the plurality of sequences stored in a text database 650 until the user instructs the processor(s) to continue 615. FIG. 6B depicts an example of a user interface for displaying static instructional text 611, in accordance with one embodiment of the present invention. The user may browse the text by touching previous icon 612 or next icon 613, reading sections of text as desired or moving to an associated video accessed at the end or beginning of the text sequence.

Referring to FIG. 6A, the one or more processors, then display 620 or play a video of one of the plurality of sequences corresponding to the previously displayed text sequence until the video ends 625. The video sequence is stored in a video database 655. FIG. 6C depicts an example of a user interface for displaying an instructional video 621, in accordance with one embodiment of the present invention. Referring to FIG. 6A, when the video play ends, the one or more processors, determine 630, when a last one of the plurality of sequences is displayed based on a predetermined number of sequences stored in database 650 and 655. The predetermined number of sequences is based on the complexity of the procedure and the granularity of each sequence.

The text and video sequences are associated to text and video address pointers respectively. If the text and video pointers are not at a value corresponding to an end or last pointer location, the one or more processors increment the text and video address pointers to repeat displaying the next one of the plurality of sequences, and determining when the last one of the plurality of sequences is not displayed. In another embodiment, the video sequence may be displayed before the text sequence. In another embodiment, the sequence may be displayed as text without video or as video without text. When the last one of the plurality of sequences is displayed, the one or more processors exit step by step treatment mode 600 and return 635 to reference point G in the method, i.e. displaying the training aid selection menu.

In one embodiment the plurality of sequences includes a portion of a solution procedure. In one example, the solution procedure may be a treatment of a patient. In another example the solution procedure may repair a machine or describe the operation of a machine

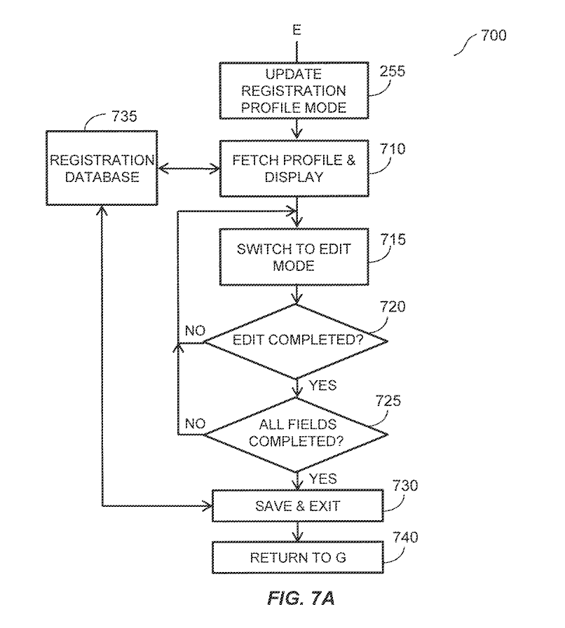

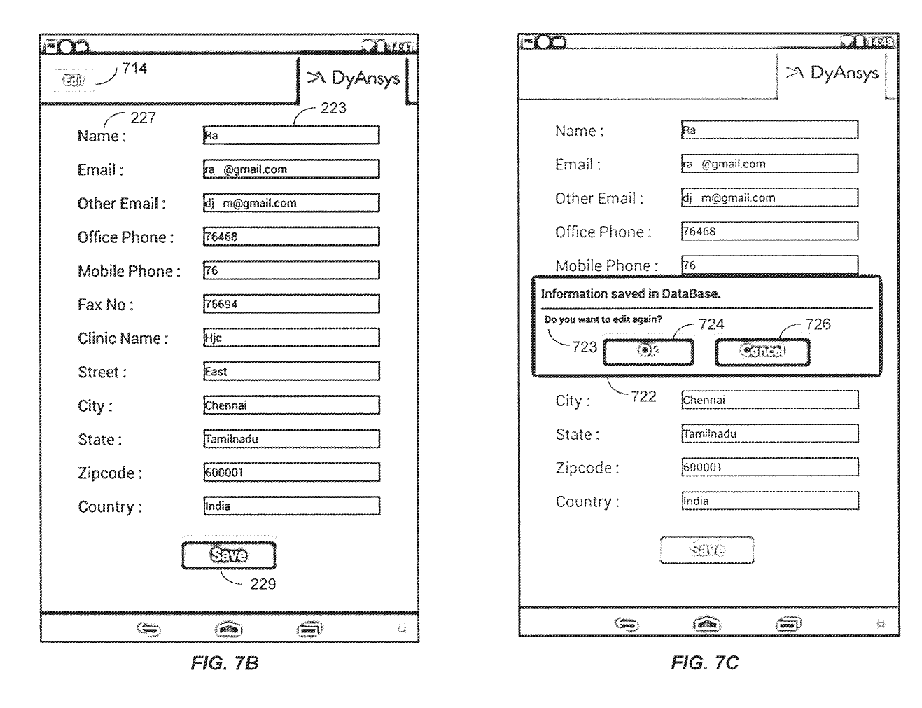

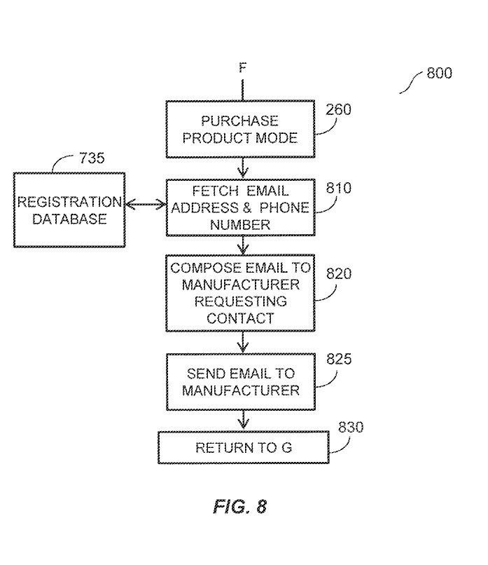

FIG. 7A depicts a simplified, flow chart of a computer-implemented method for an update-registration-profile mode 700 represented in FIG. 2A, in accordance with one embodiment of the present invention. Referring to FIG. 7A, when the update-registration-profile mode is selected 255 by the user, the one or more processors access 710 or fetch the profile from a database 735 storing the profile of the user and display the profile on the screen. FIG. 7B depicts an example of a user interface for updating the user registration, in accordance with one embodiment of the present invention. The registration screen has the same information fields as referenced in FIG. 2C. FIG. 7B depicts an edit icon 714, which is available to switch into edit mode when the icon is touched by the user.

Referring to FIG. 7A, when the display on the screen is switched 715 to an edit mode with the one or more processors, the edit mode continues until the user completes 720 editing the profile using the screen as a graphical user interface. The one or more processors check 725 that all the required fields are filled in or completed, and store or save 730 the profile in registration database 735 when the editing is completed. FIG. 7C depicts an example of a user interface for completing the user registration update, in accordance with one embodiment of the present invention. Multitude of information fields 223 and multitude of associated descriptive text lines 227 may be displayed behind a smaller window 722 displayed in the foreground that displays a question if the user wants to edit again 723, an OK icon 724, and a cancel icon 726, which are activated by user touch. To edit again, the user touches OK icon 724. To complete the editing and storing, the user touches cancel icon 726. Referring to FIG. 7A, when the storing is completed, the one or more processors exit update registration profile mode 700 and return 740 to reference point G in the method, i.e. displaying the training aid selection menu.

FIG. 8 depicts a simplified, flow chart of a computer-implemented method for purchase product mode 800 represented in FIG. 2A, in accordance with one embodiment of the present invention. Referring to FIG. 8, when the purchase product mode is selected 260 by the user, the one or more processors access 810 or fetch an email address from the profile from registration database 735 that stores the profile of the user. The one or more processors, compose 820 an email to an entity associated with the procedure. The entity may be a manufacturer of equipment or devices associated with the procedure and the email may be composed so as to request the manufacturer contact the user for completing a purchase of the equipment or devices.

In one embodiment, user entry into the purchase product mode may require successful completion of test mode 410b. In another embodiment, user entry into the purchase product mode may be at the user's discretion. The one or more processors, then send 825 the email to the entity via the smartphone. In another embodiment, the entity may be a supervisor of the user and the email may inform the supervisor of the user's successful completion of training for the procedure. When the sending is completed, the one or more processors exit purchase product mode 800 and return 830 to reference point G in the method, i.e. displaying the training aid selection menu.

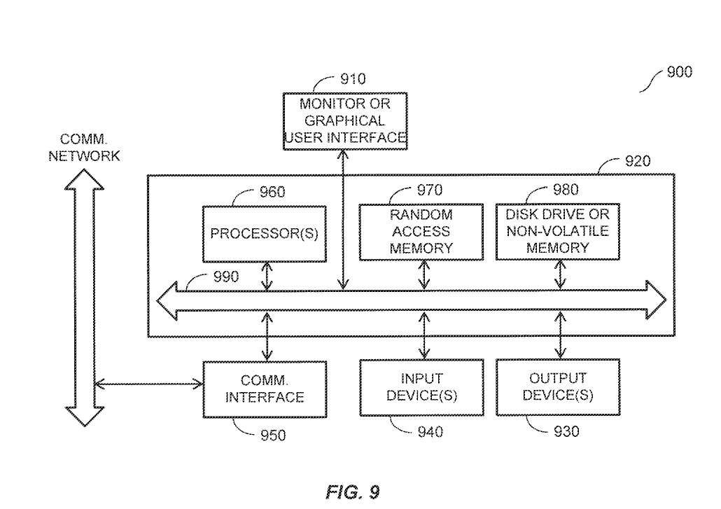

FIG. 9 depicts a simplified block diagram of a computer system that may incorporate embodiments of the present invention. FIG. 9 is merely illustrative of an embodiment incorporating the present invention and does not limit the scope of the invention as recited in the claims. One of ordinary skill in the art would recognize other variations, modifications, and alternatives.

In one embodiment, computer system 900 typically includes a monitor or 910, a computer 920, user output devices 930, user input devices 940, communications interface 950, and the like. Computer system 900 may also be a smart phone, tablet-computing device, and the like, such that the boundary of computer 920 may enclose monitor or graphical user interface 910, user output devices 930, user input devices 940, and/or communications interface 950 (not shown).

As depicted in FIG. 9, computer 920 may include a processor(s) 960 that communicates with a number of peripheral devices via a bus subsystem 990. These peripheral devices may include user output devices 930, user input devices 940, communications interface 950, and a storage subsystem, such as random access memory (RAM) 970 and disk drive or non-volatile memory 980.

User input devices 930 include all possible types of devices and mechanisms for inputting information to computer system 920. These may include a keyboard, a keypad, a touch screen incorporated into the display, audio input devices such as voice recognition systems, microphones, and other types of input devices. In various embodiments, user input devices 930 are typically embodied as a computer mouse, a trackball, a track pad, a joystick, wireless remote, drawing tablet, voice command system, eye tracking system, and the like. User input devices 930 typically allow a user to select objects, icons, text and the like that appear on the monitor or graphical user interface 910 via a command such as a click of a button, touch of the display screen, or the like.

User output devices 940 include all possible types of devices and mechanisms for outputting information from computer 920. These may include a display (e.g., monitor or graphical user interface 910), non-visual displays such as audio output devices, etc.

Communications interface 950 provides an interface to other communication networks and devices. Communications interface 950 may serve as an interface for receiving data from and transmitting data to other systems. Embodiments of communications interface 950 typically include an Ethernet card, a modem (telephone, satellite, cable, ISDN), (asynchronous) digital subscriber line (DSL) unit, FireWire interface, USB interface, and the like. For example, communications interface 950 may be coupled to a computer network, to a FireWire bus, or the like. In other embodiments, communications interfaces 950 may be physically integrated on the motherboard of computer 920, and may be a software program, such as soft DSL, or the like. Embodiments of communications interface 950 may also include a wireless radio transceiver using radio transmission protocols such as Bluetooth®, WiFi®, cellular, and the like.

In various embodiments, computer system 900 may also include software that enables communications over a network such as the HTTP, TCP/IP, RTP/RTSP protocols, and the like. In alternative embodiments of the present invention, other communications software and transfer protocols may also be used, for example IPX, UDP or the like.

In some embodiment, computer 920 includes one or more Xeon microprocessors from Intel as processor(s) 960. Further, one embodiment, computer 920 includes a UNIX-based operating system. In another embodiment the processor may be included in an applications processor or part of a system on a chip.

RAM 970 and disk drive or non-volatile memory 980 are examples of tangible media configured to store data such as embodiments of the present invention, including executable computer code, human readable code, or the like. Other types of tangible media include floppy disks, removable hard disks, optical storage media such as CD-ROMS, DVDs and bar codes, semiconductor memories such as flash memories, read-only-memories (ROMS), battery-backed volatile memories, networked storage devices, and the like. RAM 970 and disk drive or non-volatile memory 980 may be configured to store the basic programming and data constructs that provide the functionality of the present invention.

Software code modules and instructions that provide the functionality of the present invention may be stored in RAM 970 and disk drive or non-volatile memory 980. These software modules may be executed by processor(s) 960. RAM 970 and disk drive or non-volatile memory 980 may also provide a repository for storing data used in accordance with the present invention.

RAM 970 and disk drive or non-volatile memory 980 may include a number of memories including a main random access memory (RAM) for storage of instructions and data during program execution and a read only memory (ROM) in which fixed instructions are stored. RAM 970 and disk drive or non-volatile memory 980 may include a file storage subsystem providing persistent (non-volatile) storage for program and data files. RAM 970 and disk drive or non-volatile memory 980 may also include removable storage systems, such as removable flash memory.

Bus subsystem 990 provides a mechanism for letting the various components and subsystems of computer 920 communicate with each other as intended. Although bus subsystem 990 is shown schematically as a single bus, alternative embodiments of the bus subsystem may utilize multiple busses.

FIG. 9 is representative of a computer system capable of embodying the present invention. It will be readily apparent to one of ordinary skill in the art that many other hardware and software configurations are suitable for use with the present invention. For example, the computer may be a desktop, laptop, portable, rack-mounted, smart phone or tablet configuration. Additionally, the computer may be a series of networked computers. Further, the use of other microprocessors are contemplated, such as Pentium™ or Itanium™ microprocessors; Opteron™ or AthlonXP™ microprocessors from Advanced Micro Devices, Inc; embedded processors such as ARM® licensed from ARM® Holdings plc., and the like. Further, other types of operating systems are contemplated, such as Windows®, WindowsXP®, WindowsNT®, WindowsRT® or the like from Microsoft Corporation, Solaris from Sun Microsystems, LINUX, UNIX, or mobile operating systems such as Android® from Google Inc., iOS® from Apple Inc., Symbion® from Nokia Corp., and the like. In still other embodiments, the techniques described above may be implemented upon a chip or an auxiliary processing board.

Various embodiments of the present invention can be implemented in the form of logic in software or hardware or a combination of both. The logic may be stored in a computer readable or machine-readable storage medium as a set of instructions adapted to direct a processor of a computer system to perform a set of steps disclosed in embodiments of the present invention. The logic may form part of a computer program product adapted to direct an information-processing device to perform a set of steps disclosed in embodiments of the present invention. Based on the disclosure and teachings provided herein, a person of ordinary skill in the art will appreciate other ways and/or methods to implement the present invention.

The above embodiments of the present invention are illustrative and not limiting. Various alternatives and equivalents are possible. Although, the invention has been described with reference to teaching a procedure for treating a human patient with auricular acupuncture electrotherapy by way of an example, it is understood that the invention is not limited by the type of procedure. Although, the invention has been described with reference to entering user selections via icons displayed on a touch sensitive screen by way of an example, it is understood that the invention is not limited by the type of user data entry. For example, user data entry may be provided by pressing buttons on a computer device, via a graphical user interface/mouse selection, or by voice command, and the like. Although, the invention has been described with reference to certain radio communications interface by way of an example, it is understood that the invention is not limited by the type of radio communications interface. Although, the invention has been described with reference to certain operating systems by way of an example, it is understood that the invention is not limited by the type of operating systems. Other additions, subtractions, or modifications are obvious in view of the present disclosure and are intended to fall within the scope of the appended claims.

What is claimed is:

1. A computer-implemented method for training a user in a procedure, the method comprising:
registering, with one or more processors associated with a computer, a profile of the user;
receiving, with the one or more processors, a selection of a training aid from a menu using a graphical user interface of the computer; and
displaying, with the one or more processors, the training aid on the graphical user interface of the computer, the training aid being responsive to an input from the user,
wherein the training aid accesses, with the one or more processors, a storage space of the computer comprising
a first database storing a graphical representation associated with the procedure,
a second database storing a plurality of questions and a plurality of associated answers, the plurality of questions being associated with the procedure,
a third database storing a plurality of symptoms and a plurality of associated solutions, the plurality of symptoms being associated with the procedure, and
a fourth database storing a plurality of sequences associated with the procedure.

2. The method of claim 1, wherein the procedure includes a stimulative electrotherapy.

3. The method of claim 1, wherein displaying, with the one or more processors, the training aid comprises:
displaying, with the one or more processors, on the graphical user interface the graphical representation;
receiving, with the one or more processors, a selection of one of a plurality of locations on the graphical representation using the graphical user interface;
accessing, with the one or more processors, a description associated with the selection from a fifth database;
displaying, with the one or more processors, on the graphical user interface the description on the graphical user interface; and
repeating, with the one or more processors, displaying the graphical representation, receiving a selection, accessing a description, and displaying the description until an exit command is received.

4. The method of claim 3 further comprising:
displaying, with the one or more processors, on the graphical user interface a plurality of icons associated with a plurality of graphical views of the graphical representation;
receiving, with the one or more processors, a selection of one of the plurality of icons associated with the plurality of graphical views using the graphical user interface; and
displaying, with the one or more processors, on the graphical user interface a selected one of the plurality of graphical views on the graphical user interface.

5. The method of claim 3, wherein displaying, with the one or more processors, the training aid further comprises:
returning, with the one or more processors, to receiving a selection of a training aid from a menu when an exit command is received.

6. The method of claim 3, wherein the graphical representation includes a portion of an anatomy of a patient.

7. The method of claim 6, wherein the portion of the anatomy includes a skin surface.

8. The method of claim 7, wherein the skin surface includes an ear.

9. The method of claim 3, wherein the description includes a symptom of a patient.

10. The method of claim 9, wherein the description includes a symptom treated with a stimulative electrotherapy based on a western medicine protocol.

11. The method of claim 9, wherein the description includes a symptom treated with a stimulative electrotherapy based on an eastern medicine protocol.

12. The method of claim 1, wherein displaying, with the one or more processors, the training aid comprises:
accessing, with the one or more processors, at least one of the plurality of questions and at least one of the plurality of associated answers;
displaying, with the one or more processors, on the graphical user interface the at least one of the plurality of questions on the graphical user interface;
receiving, with the one or more processors, an answer input using the graphical user interface;
determining, with the one or more processors, when a last question is displayed based on a predetermined number of questions to be accessed from the second database; and
repeating, with the one or more processors, when the last question is not displayed, displaying the at least one of the plurality of questions, receiving an answer input, and determining.

13. The method of claim 12, wherein displaying, with the one or more processors, the training aid further comprises:
returning, with the one or more processors, to receiving a selection of a training aid from a menu when the last question is displayed.

14. The method of claim 12, wherein displaying, with the one or more processors, the training aid further comprises:
displaying, with the one or more processors, on the graphical user interface a plurality of icons associated with a plurality of training modes; and
receiving, with the one or more processors, a selection of one of the plurality of icons using the graphical user interface.

15. The method of claim 12, wherein displaying, with the one or more processors, the training aid further comprises:
comparing, with the one or more processors, the answer input with the at least one of the plurality of associated answers;
determining, with the one or more processors, a comparison outcome based on comparing the answer input with the at least one of the plurality of associated answers, the comparison outcome being positive if the answer input equals the at least one of the plurality of associated answers, the comparison outcome being negative if the answer input does not equal the at least one of the plurality of associated answers;
determining, with the one or more processors, a number of positive or negative comparison outcomes; and
displaying, with the one or more processors, on the graphical user interface the number of positive or negative comparison outcomes.

16. The method of claim 12, wherein displaying, with the one or more processors, the training aid further comprises:
displaying, with the one or more processors, on the graphical user interface the answer input and the at least one of the plurality of associated answers.

17. The method of claim 12, wherein accessing, with the one or more processors, the at least one of the plurality of questions and the at least one of the plurality of associated answers is done in a predetermined order, wherein repeating, with the one or more processors, includes accessing.

18. The method of claim 12, wherein accessing, with the one or more processors, the at least one of the plurality of questions and the at least one of the plurality of associated answers is done in a random order to select a predetermined number of questions.

19. The method of claim 12, wherein the least one of the plurality of questions is associated with a treatment of a dysfunction of a patient.

20. The method of claim 19, wherein the treatment is associated with a stimulative electrotherapy.

21. The method of claim 1, wherein displaying, with the one or more processors, the training aid comprises:
displaying, with the one or more processors, on the graphical user interface a portion of the plurality of symptoms;
receiving, with the one or more processors, a selected one of the portion of the plurality of symptoms using the graphical user interface;
accessing, with the one or more processors, one of the plurality of associated solutions based on the selected one of the portion of the plurality of symptoms; and
displaying, with the one or more processors, on the graphical user interface the one of the plurality of associated solutions.

22. The method of claim 21, wherein displaying, with the one or more processors, the training aid further comprises:
returning, with the one or more processors, to receiving a selection of a training aid from a menu after displaying the one of the plurality of associated solutions.

23. The method of claim 21, wherein displaying, with the one or more processors, the training aid further comprises:
displaying, with the one or more processors, on the graphical user interface a plurality of icons associated with a plurality of display modes; and
receiving, with the one or more processors, a selection of one of the plurality of icons using the graphical user interface.

24. The method of claim 21, wherein displaying, with the one or more processors, the plurality of symptoms includes:
displaying, with the one or more processors, on the graphical user interface a table of the portion of the plurality of symptoms until the selected one of the portion of the plurality of symptoms is received.

25. The method of claim 21, wherein displaying, with the one or more processors, the plurality of symptoms includes:
displaying, with the one or more processors, on the graphical user interface a graphical view related to the plurality of symptoms and stored in a fifth database; and
receiving, with the one or more processors, a selection of one of a plurality of locations on the graphical view using the graphical user interface, wherein the selection is associated with the selected one of the portion of the plurality of symptoms.

26. The method of claim 25, wherein the graphical view includes a portion of an anatomy of a patient.

27. The method of claim 21, wherein the plurality of symptoms are associated with a dysfunction of a patient.

28. The method of claim 27, wherein the plurality of associated solutions are associated with a plurality of locations on a skin of the patient associated with a stimulative electrotherapy.

29. The method of claim 1, wherein displaying, with the one or more processors, the training aid comprises:
displaying, with the one or more processors, on the graphical user interface one of the plurality of sequences;
determining, with the one or more processors, when a last one of the plurality of sequences is displayed based on a predetermined number of sequences; and
repeating, with the one or more processors, displaying one of the plurality of sequences, and determining when the last one of the plurality of sequences is not displayed.

30. The method of claim 29, wherein displaying, with the one or more processors, the training aid further comprises:
returning, with the one or more processors, to receiving a selection of a training aid from a menu when the last one of the plurality of sequences is displayed.

31. The method of claim 29, wherein the plurality of sequences are displayed in a predetermined order.

32. The method of claim 29, wherein displaying, with the one or more processors, one of the plurality of sequences includes:
displaying, with the one or more processors, a text of one of the plurality of sequences.

33. The method of claim 29, wherein displaying, with the one or more processors, one of the plurality of sequences includes:
displaying, with the one or more processors, a video of one of the plurality of sequences.

34. The method of claim 29, wherein displaying, with the one or more processors, one of the plurality of sequences includes:
displaying, with the one or more processors, a text of one of the plurality of sequences; and
displaying, with the one or more processors, a video of one of the plurality of sequences.

35. The method of claim 29, wherein one of the plurality of sequences includes a portion of a solution procedure.

36. The method of claim 1, wherein registering, with one or more processors associated with a computer, the profile of the user comprises:
accessing, with the one or more processors, the profile from a fifth database storing the profile of the user;
displaying, with the one or more processors, on the graphical user interface the profile;
editing, with the one or more processors, the profile using the graphical user interface; and
storing, with the one or more processors, the profile in the fifth database when the editing is completed.

37. The method of claim 36, wherein registering, with the one or more processors, a profile of the user further comprises:
returning, with the one or more processors, to receiving a selection of a training aid from a menu when the storing is completed.

38. The method of claim 1, wherein displaying, with the one or more processors, the training aid comprises:
accessing, with the one or more processors, an email address from the profile from a fifth database storing the profile of the user;
composing, with the one or more processors, an email to an entity associated with the procedure; and
sending, with the one or more processors, the email to the entity.

39. The method of claim 38, wherein the entity is a manufacturer and the email is composed so as to request the manufacturer contact the user.

40. The method of claim 38, wherein registering, with the one or more processors, a profile of the user further comprises:
returning, with the one or more processors, to receiving a selection of a training aid from a menu when the sending is completed.

41. A non-transitory computer-readable medium storing computer-executable code for training a user in a procedure, the non-transitory computer-readable medium comprising:
code for registering a profile of the user;
code for receiving a selection of a training aid from a menu using a graphical user interface of the computer; and
code for displaying the training aid on the graphical user interface of the computer, the training aid being responsive to an input from the user,
wherein the training aid accesses a storage space of the computer comprising
a first database storing a graphical representation associated with the procedure,
a second database storing a plurality of questions and a plurality of associated answers, the plurality of questions being associated with the procedure,
a third database storing a plurality of symptoms and a plurality of associated solutions, the plurality of symptoms being associated with the procedure, and
a fourth database storing a plurality of sequences associated with the procedure.

42. The non-transitory computer-readable medium of claim 41, wherein the procedure includes a stimulative electrotherapy.

43. The non-transitory computer-readable medium of claim 41, wherein the code for displaying the training aid comprises:
code for displaying on the graphical user interface the graphical representation;
code for receiving a selection of one of a plurality of locations on the graphical representation using the graphical user interface;
code for accessing a description associated with the selection from a fifth database;
code for displaying on the graphical user interface the description on the graphical user interface; and
code for repeating displaying the graphical representation, receiving a selection, accessing a description, and displaying the description until an exit command is received.

44. The non-transitory computer-readable medium of claim 43 further comprising:
code for displaying on the graphical user interface a plurality of icons associated with a plurality of graphical views of the graphical representation;
code for receiving a selection of one of the plurality of icons associated with the plurality of graphical views using the graphical user interface; and
code for displaying on the graphical user interface a selected one of the plurality of graphical views on the graphical user interface.

45. The non-transitory computer-readable medium of claim 43, wherein the code for displaying the training aid further comprises:
code for returning to receiving a selection of a training aid from a menu when an exit command is received.

46. The non-transitory computer-readable medium of claim 43, wherein the graphical representation includes a portion of an anatomy of a patient.

47. The non-transitory computer-readable medium of claim 46, wherein the portion of the anatomy includes a skin surface.

48. The non-transitory computer-readable medium of claim 47, wherein the skin surface includes an ear.

49. The non-transitory computer-readable medium of claim 43, wherein the description includes a symptom of a patient.

50. The non-transitory computer-readable medium of claim 49, wherein the description includes a symptom treated with a stimulative electrotherapy based on a western medicine protocol.

51. The non-transitory computer-readable medium of claim 49, wherein the description includes a symptom treated with a stimulative electrotherapy based on an eastern medicine protocol.

52. The non-transitory computer-readable medium of claim 41, wherein the code for displaying the training aid comprises:
code for accessing at least one of the plurality of questions and at least one of the plurality of associated answers;
code for displaying on the graphical user interface the at least one of the plurality of questions on the graphical user interface;
code for receiving an answer input using the graphical user interface;
code for determining when a last question is displayed based on a predetermined number of questions to be accessed from the second database; and
code for repeating when the last question is not displayed, accessing, displaying the at least one of the plurality of questions, receiving an answer input, and determining.

53. The non-transitory computer-readable medium of claim 52, wherein the code for displaying the training aid further comprises:
code for returning to receiving a selection of a training aid from a menu when the last question is displayed.

54. The non-transitory computer-readable medium of claim 52, wherein the code for displaying the training aid further comprises:
code for displaying on the graphical user interface a plurality of icons associated with a plurality of training modes; and
code for receiving a selection of one of the plurality of icons using the graphical user interface.

55. The non-transitory computer-readable medium of claim 52, wherein the code for displaying the training aid further comprises:
code for comparing the answer input with the at least one of the plurality of associated answers;
code for determining a comparison outcome based on comparing the answer input with the at least one of the plurality of associated answers, the comparison outcome being positive if the answer input equals the at least one of the plurality of associated answers, the comparison outcome being negative if the answer input does not equal the at least one of the plurality of associated answers;
code for determining a number of positive or negative comparison outcomes; and
code for displaying on the graphical user interface the number of positive or negative comparison outcomes.

56. The non-transitory computer-readable medium of claim 52, wherein the code for displaying the training aid further comprises:
code for displaying on the graphical user interface the answer input and the at least one of the plurality of associated answers.

57. The non-transitory computer-readable medium of claim 52, wherein the code for accessing the at least one of the plurality of questions and the at least one of the plurality of associated answers is done in a predetermined order.

58. The non-transitory computer-readable medium of claim 52, wherein the code for accessing the at least one of the plurality of questions and the at least one of the plurality of associated answers is done in a random order to select a predetermined number of questions.

59. The non-transitory computer-readable medium of claim 52, wherein the at least one of the plurality of questions is associated with a treatment of a dysfunction of a patient.

60. The non-transitory computer-readable medium of claim 62, wherein the treatment is associated with a stimulative electrotherapy.

61. The non-transitory computer-readable medium of claim 41, wherein the code for displaying the training aid comprises:
code for displaying on the graphical user interface a portion of the plurality of symptoms;
code for receiving a selected one of the portion of the plurality of symptoms using the graphical user interface;
code for accessing one of the plurality of associated solutions based on the selected one of the portion of the plurality of symptoms; and
code for displaying on the graphical user interface the one of the plurality of associated solutions.

62. The non-transitory computer-readable medium of claim 61, wherein the code for displaying the training aid further comprises:
code for returning to receiving a selection of a training aid from a menu after displaying the one of the plurality of associated solutions.

63. The non-transitory computer-readable medium of claim 61, wherein the code for displaying the training aid further comprises:
code for displaying on the graphical user interface a plurality of icons associated with a plurality of display modes; and
code for receiving a selection of one of the plurality of icons using the graphical user interface.

64. The non-transitory computer-readable medium of claim 61, wherein the code for displaying the plurality of symptoms includes:
code for displaying on the graphical user interface a table of the portion of the plurality of symptoms until the selected one of the portion of the plurality of symptoms is received.

65. The non-transitory computer-readable medium of claim 61, wherein the code for displaying the plurality of symptoms includes:
code for displaying on the graphical user interface a graphical view related to the plurality of symptoms and stored in a fifth database; and
code for receiving a selection of one of a plurality of locations on the graphical view using the graphical user interface, wherein the selection is associated with the selected one of the portion of the plurality of symptoms.

66. The non-transitory computer-readable medium of claim 65, wherein the graphical view includes a portion of an anatomy of a patient.

67. The non-transitory computer-readable medium of claim 61, wherein the plurality of symptoms are associated with a dysfunction of a patient.

68. The non-transitory computer-readable medium of claim 67, wherein the plurality of associated solutions are associated with a plurality of locations on a skin of the patient associated with a stimulative electrotherapy.

69. The non-transitory computer-readable medium of claim 41, wherein the code for displaying the training aid comprises:
code for displaying on the graphical user interface one of the plurality of sequences;
code for determining when a last one of the plurality of sequences is displayed based on a predetermined number of sequences; and
code for repeating displaying one of the plurality of sequences, and determining when the last one of the plurality of sequences is not displayed.

70. The non-transitory computer-readable medium of claim 69, wherein the code for displaying the training aid further comprises:
code for returning to receiving a selection of a training aid from a menu when the last one of the plurality of sequences is displayed.

71. The non-transitory computer-readable medium of claim 69, wherein the plurality of sequences are displayed in a predetermined order.

72. The non-transitory computer-readable medium of claim 69, wherein the code for displaying one of the plurality of sequences includes:
code for displaying a text of one of the plurality of sequences.

73. The non-transitory computer-readable medium of claim 69, wherein the code for displaying one of the plurality of sequences includes:
code for displaying a video of one of the plurality of sequences.

74. The non-transitory computer-readable medium of claim 69, wherein the code for displaying one of the plurality of sequences includes:
code for displaying a text of one of the plurality of sequences; and
code for displaying a video of one of the plurality of sequences.

75. The non-transitory computer-readable medium of claim 69, wherein one of the plurality of sequences includes a portion of a solution procedure.

76. The non-transitory computer-readable medium of claim 41, wherein the code for registering the profile of the user comprises:
code for accessing the profile from a fifth database storing the profile of the user;
code for displaying on the graphical user interface the profile;
code for editing the profile using the graphical user interface; and
code for storing the profile in the fifth database when the editing is completed.

77. The non-transitory computer-readable medium of claim 76, wherein the code for registering a profile of the user further comprises:
code for returning to receiving a selection of a training aid from a menu when the storing is completed.

78. The non-transitory computer-readable medium of claim 41, wherein the code for displaying the training aid comprises:
code for accessing an email address from the profile from a fifth database storing the profile of the user;
code for composing an email to an entity associated with the procedure; and
code for sending the email to the entity.

79. The non-transitory computer-readable medium of claim 78, wherein the entity is a manufacturer and the email is composed so as to request the manufacturer contact the user.

80. The non-transitory computer-readable medium of claim 78, wherein the code for registering a profile of the user further comprises:
code for returning to receiving a selection of a training aid from a menu when the sending is completed.

81. A non-transitory computer-readable medium storing computer-executable code for training a user in a procedure, the non-transitory computer-readable medium comprising:
code for registering a profile of the user;
code for receiving a selection of a training aid from a menu using a graphical user interface of the computer; and
code for displaying the training aid on the graphical user interface of the computer, the training aid being responsive to an input from the user,
wherein the training aid accesses a storage space of the computer comprising
a first database storing a graphical representation associated with the procedure,
a second database storing a plurality of questions and a plurality of associated answers, the plurality of questions being associated with the procedure,
a third database storing a plurality of symptoms and a plurality of associated solutions, the plurality of symptoms being associated with the procedure, and
a fourth database storing a plurality of sequences associated with the procedure,
wherein when the selection is a first selection, the code for displaying the training aid comprises
code for accessing at least one of the plurality of questions and at least one of the plurality of associated answers,
code for displaying on the graphical user interface the at least one of the plurality of questions on the graphical user interface,
code for receiving an answer input using the graphical user interface,
code for determining when a last question is displayed based on a predetermined number of questions to be accessed from the second database, and
code for repeating when the last question is not displayed, accessing, displaying the at least one of the plurality of questions, receiving an answer input, and determining, and
wherein when the selection is a second selection, the code for displaying the training aid comprises
code for displaying on the graphical user interface a portion of the plurality of symptoms,
code for receiving a selected one of the portion of the plurality of symptoms using the graphical user interface,
code for accessing one of the plurality of associated solutions based on the selected one of the portion of the plurality of symptoms, and
code for displaying on the graphical user interface the one of the plurality of associated solutions.
